(19) United States
(12) Patent Application Publication
(10) Pub. No.: US 2014/0019880 A1
(43) Pub. Date: Jan. 16, 2014

(54) COMMUNITY SWITCHING

(71) Applicant: SALESFORCE.COM, INC., San Francisco, CA (US)

(72) Inventors: John Kucera, San Francisco, CA (US); Aditya Kuruganti, San Francisco, CA (US); William Charles Mortimore, JR., San Francisco, CA (US)

(73) Assignee: salesforce.com, inc., San Francisco, CA (US)

(21) Appl. No.: 13/804,739

(22) Filed: Mar. 14, 2013

Related U.S. Application Data
(60) Provisional application No. 61/670,201, filed on Jul. 11, 2012.

(51) Int. Cl. H04L 29/06

(52) U.S. Cl. CPC H04L 65/403
USPC 715/753

(57) ABSTRACT

Disclosed are methods, apparatus, systems, and computer-readable storage media for maintaining communities and providing access to communities of users in an online social network. In some implementations, an internal user of an organization is provided access to a community switcher user interface component in a user interface for switching between an external community and an internal community established at a domain associated with an organization. The external community is established at an external community root domain. A community switcher user interface component can be requested and displayed at a computing device. The community switcher user interface component includes a link to the internal community and a link to the external community.

### PRIORITY AND RELATED APPLICATION DATA

This patent document claims priority to co-pending and commonly assigned U.S. Provisional Patent Application No. 61/670,201, filed on Jul. 11, 2012, entitled “COMMUNITY SWITCHING,” by Kucera et al. (Attorney Docket No. 946PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This patent document relates generally to in an online social network using a database system and, more specifically, to techniques for switching among communities of users in the social network.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

Database resources can be provided in a cloud computing context. However, using conventional database management techniques, it is difficult to know about the activity of other users of a database system in the cloud or other network. For example, the actions of a particular user, such as a salesperson, on a database resource may be important to the user's boss. The user can create a report about what the user has done and send it to the boss, but such reports may be inefficient, not timely, and incomplete. Also, it may be difficult to identify other users who might benefit from the information in the report.

### BRIEF DESCRIPTION OF THE DRAWINGS

The included drawings are for illustrative purposes and serve only to provide examples of possible structures and process steps for the disclosed inventive systems, apparatus, methods and computer-readable media for switching among communities in one or more online social networks. These drawings in no way limit any changes in form and detail that may be made to embodiments by one skilled in the art without departing from the spirit and scope of the disclosure.

FIG. 1 shows a system diagram of an example of a social networking environment 100 with communities according to some implementations.

FIG. 2 shows a flowchart of an example of a computer implemented method 200 for providing access to communities of users in an online social network, performed in accordance with some implementations.

FIG. 3 shows a system diagram of an example of a social networking environment 300 with communities according to some implementations.

FIG. 4 shows an example of a user identity (ID) mapping table 400 identifying communities to which a user can be provided access, according to some implementations.

FIG. 5 shows an example of a privileges table 500 identifying rights and restrictions of users to access data and initiate actions in one or more communities according to one or more attributes, according to some implementations.

FIG. 6 shows an example of a privileges table 600 identifying different access models governing permissions of users to access data and initiate actions in one or more communities according to one or more attributes, according to some implementations.

FIG. 7 shows an example of an access model customization window 700 as displayed in a graphical user interface (GUI) on a display device, according to some implementations.

FIG. 8 shows a flowchart of an example of a computer implemented method 800 for providing communities in an online social network, performed in accordance with some implementations.

FIG. 9 shows a flowchart of an example of a computer implemented method 900 for providing communities in an online social network, performed in accordance with some implementations.

FIG. 10 shows a flowchart of an example of a computer-implemented method 1000 for providing an internal user a community switcher user interface component for switching between an external community that the internal user is a member of and an internal community, performed in accordance with some implementations.

FIG. 11A shows a flowchart of two examples of a computer implemented method 1116 for determining that an active second session associated with the organizational domain exists, performed in accordance with some implementations.

FIG. 11B shows a flowchart of two examples of a computer implemented method 1132 for determining that an active first session associated with the external community root domain exists, performed in accordance with some implementations.

FIG. 12 shows a flowchart of an example of a computer implemented method 1200 for providing an internal user of an organization access to a community resource, performed in accordance with some implementations.

FIG. 13 shows a flowchart of an example of a computer implemented method 1340 for receiving and responding to user activity, as one of various implementations of block 1240 of method 1200, performed in accordance with some implementations.

FIG. 14 shows a flowchart of an example of a computer implemented method 1440 for receiving and responding to user activity, as another one of various implementations of block 1240 of method 1200, performed in accordance with some implementations.

FIG. 15 shows an example of an internal community presented in a user interface, according to some implementations.

FIG. 16 shows an example of a community switcher user interface component presented in a user interface of an internal community, according to some implementations.

FIG. 17 shows an example of an external community presented in a user interface, according to some implementations.

FIG. 18 shows an example of a community switcher user interface component presented in a user interface of an external community, according to some implementations.

FIG. 19 shows an example of a graphical user interface (GUI) including a presentation of an external community login page to a user at a computing device, according to some implementations.

FIG. 20 shows an example of a graphical user interface (GUI) including a presentation of an internal community login page to a user at a computing device, according to some implementations.

FIG. 21 shows an example of a community switcher user interface component, according to some implementations.

FIG. 22 shows an example of a community switcher user interface component, according to some implementations.

FIG. 23A shows a block diagram of an example of an environment 10 in which an on-demand database service can be used in accordance with some implementations.

FIG. 23B shows a block diagram of an example of some implementations of elements of FIG. 23A and various possible interconnections between these elements.

FIG. 24A shows a system diagram illustrating an example of architectural components of an on-demand database service environment 2400 according to some implementations.

FIG. 24B shows a system diagram further illustrating an example of architectural components of an on-demand database service environment according to some implementations.

### DETAILED DESCRIPTION

Examples of systems, apparatus, and methods according to the disclosed implementations are described in this section. These examples are being provided solely to add context and aid in the understanding of the disclosed implementations. It will thus be apparent to one skilled in the art that implementations may be practiced without some or all of these specific details. In other instances, certain process/method operations, also referred to herein as “blocks,” have not been described in detail in order to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Various implementations described or referenced herein are directed to different systems, apparatus, methods and computer-readable storage media for defining communities, maintaining communities, and providing access to communities of users in an online social network, also referred to herein as a social networking system. One example of an online social network is Chatter®, provided by salesforce.com, inc. of San Francisco, Calif. salesforce.com, inc. is a provider of both social networking services, customer relationship management (CRM) services and other database management services. These various services can be provided in a cloud computing environment, for example, in the context of a multi-tenant database system. Thus, multiple communities can be created and managed in such an environment without having to install software locally, that is, on computing devices of users accessing the communities. While the disclosed implementations are often described with reference to Chatter®, those skilled in the art should understand that the disclosed techniques can be implemented by or in conjunction with one or more other social networking systems, such as Facebook®, LinkedIn°, Twitter®, Google+®, Yammer® and Jive®.

In some implementations, a community can be provided as a secure space for different stake-holders of an organization, such as employees, customers and partners of the organization to collaborate with one another by accessing shared data, interacting with relevant tasks and business processes, and using conversational services such as chat sessions, feed-based communication, and private messaging. The community can be structured and maintained as a public and/or private space for users having different relationships with the organization to converse and collaborate in an effective manner. The users can be of different types, such as internal or external, and/or the users can have different roles, such as employee, customer, or partner, with such types and roles defining a user's relationship with the organization. For example, a partner can be an entity external to an organization that sells services and/or provides support on behalf of an employee, who is an internal user of the organization. Multiple communities can be implemented, some affiliated with different organizations, and a user can navigate across the communities in a seamless fashion from the user's perspective.

In some instances, a user can be a member of multiple communities in a single organization. In such instances, from a database management perspective, such a user can be identified in the database system with a single user account. The single user account can be linked with the multiple communities. In other instances, when a user is a member of communities of two organizations, that user may be represented in the database system with two user accounts and/or user profiles, that is, with each user account associated with a respective organization. For example, one user account can serve as a “master” source for a user name and password for authentication when the user attempts to log into the system, while a second user account has a dummy user name and no password and relies on the master source to authenticate the user when the user attempts to log in.

Each community can be structured so a community leader, system administrator, or other user having appropriate security clearance can define rules governing community membership and privileges defining: i) access and use of various community data, ii) the ability to take action or cause events to occur in relation to the community, and iii) the visibility of users to each other. In some instances, a community can be open, as is often the case with public communities, in that there are no or minimal restrictions on users to access data, initiate actions, and view other community members' profiles, regardless of user type or role with respect to an organization. Thus, in a public community, employees, customers and partners of an affiliated organization can freely view community data and each other's profiles, follow the same objects, and converse using the same feeds, by virtue of being members of the same community.

In some instances, the community can provide various collaboration tools in a branded environment, for example, with community-specific web pages providing names, themes, colors and other indicia of the names of products, service, and/or an organization offering the product or service. Thus, a community can be a space with a branded look-and-feel for people to collaborate on data pertaining to the community and often pertaining to an organization with which the community is affiliated.

The branding of a community can include custom network addresses such as uniform resource locators (URLs) with brand names included in a string of characters defining the URL. Thus, each community provided in an online social network can have a unique and branded URL customized to refer to a product, service, and/or organization by brand name. The branding of a community can also or alternatively include themes and color options presented as parts of one or more community pages to provide a look-and-feel identifying a brand of an organization. The navigation options for community pages can also be customized to include specific tabs and other components presented in a graphical user interface (GUI) that identify a brand or aspects of a brand associated with an organization.

When an organization has multiple communities—for example, a customer community, a partner community, a best practices community, and an internal employee community—one feature of the communities is the ability of a user to switch seamlessly among the communities that he is a member of using a single identity without having to login at each community. For external communities that are open for any user to join and access, an external user that is a member of those external communities may gain access to all of the communities by logging into one of the external communities. For an internal community that may contain confidential information of an organization that should be accessible only to the organization's employees, a system administrator of the organization may wish to impose login requirements for access to the internal community that are stricter than the login requirements for access to the external communities. As such, methods may be implemented to ensure that an internal user does not login via an external community and switch over to the internal community, thereby bypassing the stricter login requirements for access to the internal community. Further, session management methods may be implemented to maintain the sessions of the internal and external communities in such a way as to provide seamless community switching between internal and external communities for an internal user while maintaining restricted access to the internal community.

For example, Acme Corporation may have an internal employee community for Acme employees to collaborate, share resources, and research the Acme knowledge database, and an external customer community for Acme customers to get customer support and to ask questions and interact with other Acme customers.

Aaron is an Acme system administrator, and he is aware that the Acme employee community contains confidential information and Aaron wishes for that information to be accessible only under strict security requirements that are enforced when an employee logs in through the internal community.

Eric is an Acme employee who is a member of both the Acme employee community and the customer community. As part of his duties, Eric monitors the customer community for questions that customers raise and he opens up cases to answer their questions. When Eric does not know the answer to a customer's question, he may need to turn to the Acme employee community to collaborate with other Acme employees or research the Acme knowledge database for an answer. Eric wants to be able to switch between the employee community and the customer community without having to login to both communities. Aaron, however, does not want Eric to be able to access the resources of the employee community without logging in through the internal community login page, where certain login restrictions, such as password expiration times, login IP restrictions, and password requirements, are imposed.

Chad is an Acme customer who is a member of the Acme customer community and the Acme partners community. He logs into the Acme customer community to ask questions about his Acme products and to connect with other Acme customers to see how they are using their Acme products. Aaron wants to provide Chad an easy and convenient experience when using the Acme customer community, including being able to login easily. Therefore, Aaron does not want to impose Eric's employee login restrictions on Chad, lest Chad find the Acme customer community difficult to use. In fact, Aaron would like to allow Chad to even use account credentials from other social networking systems, such as Facebook® or Google®, to login to the Acme customer community, so that Chad does not need to remember another user name and password to get into this community.

With Eric and Chad in mind, Aaron may setup a session management system for the internal and external communities that will achieve his goals for Eric and Chad. For one thing, the system may not allow Eric to login via an external community. Rather, when Eric attempts to access an external community resource or login to an external community, the system may redirect Eric to the login page of the internal community. If the system does not know that Eric is an employee, it may display on the external community login page a link for Acme employees to click on to login via the internal community.

Once Eric is logged into the internal community, however, the system may allow him to switch freely between the internal community and external communities that Eric is a member of. To do this, when Eric switches to an external community in which he does not have an active session, the system may detect that Eric has an active session at the internal community and automatically create an active session at the external community so that Eric can switch to the external community without having to login again. Eric can then interact with Chad and open up a case in the customer community, switch to the secure employee community to find a solution to Chad's problem, and switch back to the customer community to deliver the solution to Chad, all in one convenient user interface without having to login more than once. Moreover, the system may also refresh all of the internal and external community sessions in response to Eric's activity in any of the communities, so that Eric may experience all of the communities as if they were under a single session. Similarly, if Eric logs out of one community, the system may log him out of all of his communities.

For Chad, the system may present on the login page for the customer community multiple options for Chad to login: with an Acme username and password, a Facebook® login, a Google® login, and the like. Chad may use this feature because he uses Facebook® all the time and prefers to use his Facebook® login for as many of his accounts as possible. The system may also maintain a single external session for all of Acme's external communities, so that after Chad logs into the customer community, he can subsequently switch over to the partners community without having to login again, because the two communities share a single session. Subsequent activity in either the customer community or partners community may refresh the single external communities session so that Chad can seamlessly switch between the two without having to login again.

The claimed methods describe a session management mechanism that makes this community switching and login experience for internal and external users possible while ensuring the safeguarding of access to the internal community resources.

In some implementations, one session is maintained for all of the external communities of an organization that an employee is a member of, and a separate session is maintained for the internal employee community. For example, Acme's external communities may be served from a custom root domain chosen by Acme, such as “acme.force.com”, with the path to the customer community being “acme.force.com/customercommunity” and the path to the partner community being “acme.force.com/partnercommunity”. When a user logs into the customer community, a user session associated with the root domain, “acme.force.com”, is created, and a session cookie is issued only for the root domain, “acme.force.com.” Consequently, when the user later switches to the partner community to access a resource, a user session associated with the root domain already exists, and the user may be granted access to the resource of the partner community without having to log into the partner community. In some implementations, serving the external communities from a custom root domain makes it possible to brand and customize the appearance of the external communities. In the above example, this allows Acme to create a customer community that is fully branded as an Acme community, complete with a color scheme and a URL scheme for allowing Acme customers to collaborate on the community.

In some implementations, the external community session may be refreshed by activity in any of the external communities sharing the root domain of the external community session. In the above example, because the customer community (“acme.force.com/customercommunity”) and the partner community (“acme.force.com/partnercommunity”) share the same root domain (“acme.force.com”), a user's activity in the customer community refreshes the session associated with the root domain, and thus effectively refreshes the partner community session. In other implementations, an internal community session of an employee may also be refreshed by the employee's activity in any of the external communities that he is a member of.

In some implementations, servlets may be used to bridge the internal community session and the external community root domain session. The servlets may detect sessions that are present and create the child and parent sessions as needed. For example, one servlet may be hosted at the internal community organizational domain (e.g. na1.salesforce.com), while the other servlet may be hosted at the external community root domain (e.g. acme.force.com).

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

Online social networks are increasingly becoming a common way to facilitate communication among people who can be recognized as users of a social networking system. Some online social networks can be implemented in various settings, including organizations, e.g., enterprises such as companies or business partnerships, academic institutions, or groups within such an organization. For instance, Chatter® can be used by employee users in a division of a business organization to share data, communicate, and collaborate with each other for various purposes.

In some online social networks, users can access one or more information feeds, which include information updates presented as items or entries in the feed. Such a feed item can include a single information update or a collection of individual information updates. A feed item can include various types of data including character-based data, audio data, image data and/or video data. An information feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, an online social network may allow a user to follow data objects in the form of records such as cases, accounts, or opportunities, in addition to following individual users and groups of users. The “following” of a record stored in a database, as described in greater detail below, allows a user to track the progress of that record. Updates to the record, also referred to herein as changes to the record, are one type of information update that can occur and be noted on an information feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be user-submitted messages or can otherwise be generated in response to user actions or in response to events. Examples of messages include: posts, comments, indications of a user's personal preferences such as “likes” and “dislikes”, updates to a user's status, uploaded files, and hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed, also referred to herein as the user's “wall,” which is one example of an information feed displayed on the user's profile page.

In some implementations, an information feed may be specific to a group of users of an online social network. For instance, a group of users may publish a news feed.

Members of the group may view and post to this group feed in accordance with a permissions configuration for the feed and the group. Information updates in a group context can also include changes to group status information.

In some implementations, when data such as posts or comments input from one or more users are submitted to an information feed for a particular user, group, object, or other construct within an online social network, an email notification or other type of network communication may be transmitted to all users following the user, group, or object in addition to the inclusion of the data as a feed item in one or more feeds, such as a user's profile feed, a news feed, or a record feed. In some online social networks, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “information feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different information feeds. A second user following a first user and a record can receive the feed items associated with the first user and the record for display in the second user's news feed, which is another type of information feed. In some implementations, the feed items from any number of followed users and records can be combined into a single information feed of a particular user.

As examples, a feed item can be a message, such as a user-generated post of text data, and a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and messages, such as posts, comments, likes, etc., can define group conversations and change over time.

An “entity feed” or “record feed” generally refers to a feed of feed items about a particular record in the database, such as feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” is a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

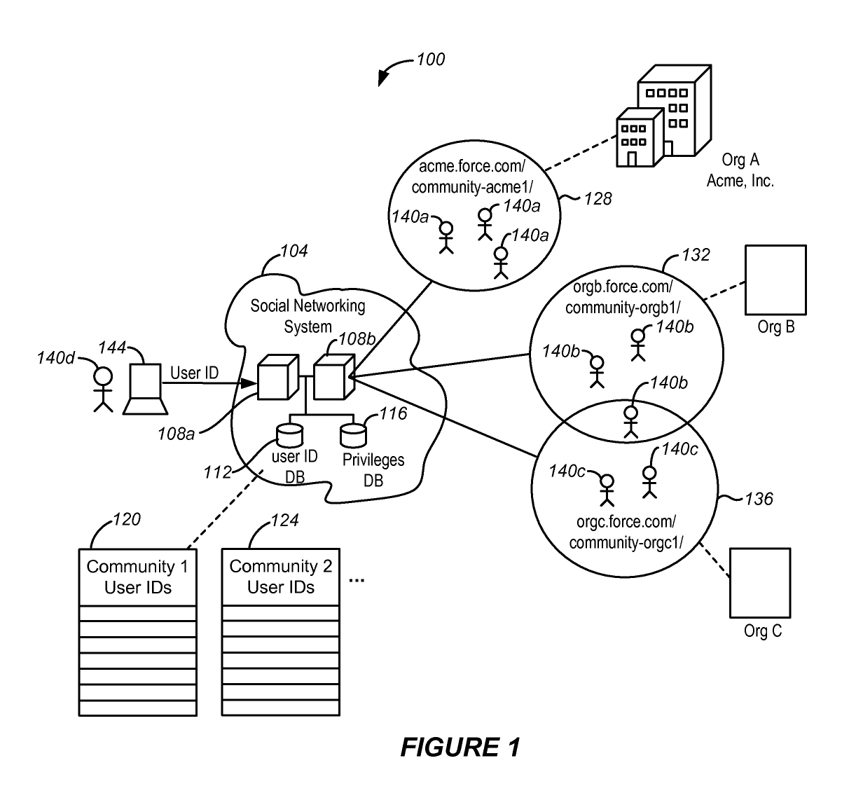

FIG. 1 shows a system diagram of an example of a social networking environment 100 with communities according to some implementations. In FIG. 1, a social networking system 104 includes any number of computing devices such as servers 108a and 108b. The servers 108a and 108b are in communication with one or more storage mediums configured to store and maintain relevant data used to perform some of the techniques disclosed herein. In this example, the storage mediums include a user ID database 112 and a privileges database 116. The user ID database 112 can maintain lists of IDs of users who are members of respective communities. By way of example, a “Community 1 User IDs” table 120 in database 112 includes a list of IDs of users who are members of Community 1, a “Community 2 User IDs” table 124 lists IDs of users who are members of Community 2, and so forth.

In FIG. 1, the privileges database 116 is configured to store privilege information identifying or specifying access rights and restrictions of users according to various attributes such as a specified user ID, type of user, role of user, type of community to which the user belongs, and/or a particular organization on behalf of which a community is maintained. Such privilege information can be customized and edited as described in greater detail below.

In FIG. 1, the social networking system servers 108 are configured to maintain one or more communities of users such as communities 128, 132 and 136 by interacting with databases 112 and 116 to identify members of those communities and privileges of members of a given community. Any number of users such as users 140a, 140b and 140c can be serviced by social networking system 104. That is, any such users 140 can have user IDs and other relevant data such as user profiles maintained in social networking system 104. By leveraging the information stored in storage mediums such as user ID database 112 and privileges database 116, communities 128, 132 and 136 of such users 140 can be defined. Thus, in this example, the community 128 includes users 140a, community 132 includes users 140b, and community 136 includes users 140c and one of users 140b. Thus, one of the users 140b is a member of both communities 132 and 136. When any such users 140 log in directly to a community, bypassing login pages of social networking system 104, or log in via social networking system 104 using a suitable computing device such as a laptop, tablet or smartphone, such users can be allowed to access data and take one or more actions available through social networking system 104 as permitted by the relevant privilege information stored in privileges database 116.

In FIG. 1, each of the communities 128, 132 and 136 is operated on behalf of a different organization. In this example, community 128 is operated on behalf of Org A, which in this example is Acme, Inc. For example, the users 140a in community 128 may be employees, customers and/or partners of Acme, Inc. By the same token, the community 132 is operated on behalf of Org B, which can be any type of organization as described in greater detail below. The community 136 is maintained on behalf of Org C. The various users in a given community can have different relationships with the organization on behalf of which the community is maintained. Thus, one or more of the users 140b can be an employee, customer or business partner of Org B. In this example, as mentioned above, one of the users 140b is a member of both communities 132 and 136. Thus, this user 140b could be an employee of Org B and a customer of Org C by way of example.

In FIG. 1, each community 128, 132 and 136 often has one or more pages of relevant community data maintained by social networking system 104, where such pages are accessible by a web browser program operating on a user's computing device. Thus, any user having access to a given community as defined by data stored in privileges database 116 can load part or all of such pages for display on the user's computing device. In the example of FIG. 1, a community's page or pages is accessible at a web domain such as a URL including an org value identifying the specific organization on behalf of which the community is maintained. This org value can be a character such as a letter, number, symbol, or string of characters identifying the specific organization with which the community is affiliated. Thus, pages or other social network data available to users 140a in community 128 can be accessed at a URL such as acme.force.com/community-acme1/. In this example of a URL, the string “acme” of “acme.force.com” can provide the org value, which identifies Acme, Inc. by name. In some instances, the “acme” of “community-acme1” can provide the org value identifying Acme, Inc. Acme, Inc. can have other web pages available to the general public, for example, at the URL acme.com, which is a different root domain than the acme.force.com address at which community-specific pages are provided.

The page or pages maintained by the social networking system 104 for community 132 can be accessed at the URL orgb.force.com/community-orgb1/. As in the example of Acme, Inc., the “orgb” of “orgb.force.com” or the “orgb” of “community-orgb1” can be the org value identifying Org B. One or more pages maintained on behalf of community 136 can similarly be accessed and identified with org values at the URL orgc.force.com/communityorgc1/.

As described in the examples below, when a user 140d directly logs in to a community using an appropriate login page at the community URL, and the user is identified as a member of a particular community, the web browser program on the user's computing device can be automatically routed to access a page at the URL specific to that user's community, such as acme.force.com/community-acme1/. The user can choose to navigate through additional pages accessible via the community or communities to which the user belongs.

In addition, as explained in greater detail in the examples below, the network address at which a community's pages are accessible can include branding information, identifying by a particular brand the community and/or the organization on behalf of which the community is maintained. Thus, in FIG. 1, in the example of community 128, the URL acme.force.com/community-acme1/ includes the name “acme” twice, that is, at the root domain and as part of the sub-domain identifying community 128. Such branding information can identify products and/or services provided by organization in some instances. Thus, a URL at which pages of community 128 are maintained can be customized to include names of brands recognizable to users having dealings with that organization, regardless of whether the users are employees, customers, partners or have other relationships with a particular organization.

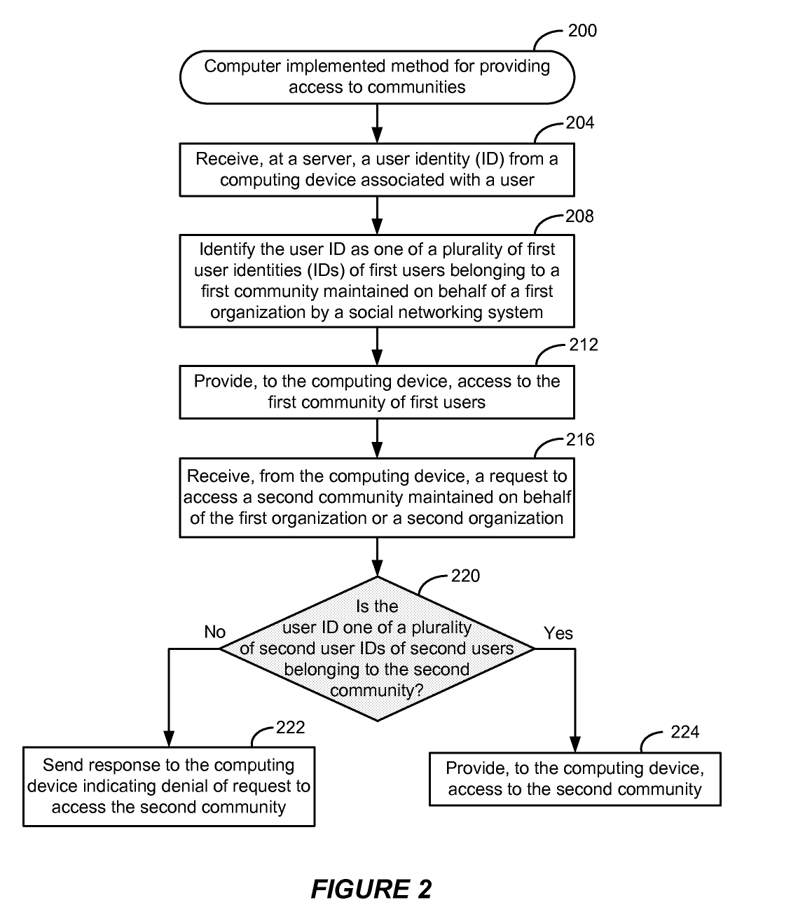

FIG. 2 shows a flowchart of an example of a computer implemented method 200 for providing access to communities of users in an online social network, performed in accordance with some implementations. In FIG. 2, at block 204, when a user 140d of FIG. 1 logs in to a community at the community URL, a computing device such as server 108a receives a user ID from a computing device 144 operated by user 140d. For example, user 140d can type his or her ID and password into an appropriate community login page displayed as a GUI on the display of device 144. At block 208, one of the servers 108 of social networking system 104 accesses user ID database 112 to identify the user ID received from computing device 144 in one or more lists of user IDs of various communities, such as tables 120 and 124.

Thus, at block 212, when the user ID received from user 140d is identified, for example, as one of the IDs of users belonging to a first community 128, access to community 128 is provided via computing device 144. The access provided at block 212 can be defined in terms of privileges to access designated data stored on behalf of community 128 and/or to take one or more actions permitted to members of the community 128, as defined by privilege information stored in privileges database 116. For example, when the user 140d is identified as an employee of Acme, Inc., privilege information stored in database 116 may indicate that user 140d is able to access user profiles of other members of community 128, access community-specific files such as .xls spreadsheets and .doc files, for instance, in the form of expense reimbursement requests and travel requests, as well as take actions such as posting messages on a community feed of community 128, posting messages on walls of users 140a, and following users 140a and records stored by social networking system 104 in association with community 128. That is, when the user 140d makes an appropriate request for such data or to take such action, for instance, through an appropriate GUI displayed on computing device 144, such a request is transmitted to a server 108 of social networking system 104, and the server 108 issues an appropriate response to computing device 144 acknowledging or denying the request in accordance with privilege information stored in database 116. Requested data, which the user has the right to access, can thus be transmitted back to computing device 144. For instance, profile data of one or more users 140a and/or community-specific file data can be transmitted from a server 108 to device 144 for viewing and further interaction by user 140d.

In FIG. 2, at block 216, during a browsing session, user 140d may submit a request via computing device 144 to access a second community maintained on behalf of the same organization, Acme, Inc., or on behalf of a different organization, such as Org B of FIG. 1. At block 220, similar to block 208 described above, a server 108 in social networking system 104 checks a list of user IDs of members of the second community to determine whether the same user ID received at block 204 from user 140d is included in the list. At block 222, when the ID of user 140d cannot be identified in the list of user IDs of users belonging to the second community, the server 108 sends a response to computing device 144 indicating that access to the second community has been denied. The content of such a response can be displayed in an appropriate GUI on the display of computing device 144.

Returning to block 220, when the user ID of user 140d is identified in the list of members of the second community, at block 224, a server or servers 108 in social networking system 104 provides access to the second community. As described above with reference to community 128 maintained on behalf of Acme, Inc., privilege information maintained in database 116 can be customized to define certain rights and restrictions of members of the second community to access social network data and initiate one or more actions, as described in greater detail below. For example, privilege information maintained in database 116 can identify user 140d as either an internal or external user of the organization on behalf of which the second community is maintained. Thus, appropriate access rights and restrictions can be assigned to internal or external users of the organization. For example, the user 140d may be an internal user of Org A and have a corresponding set of rights and restrictions with community 128, while the same user may be an external user of Org B and, thus, have a different set of rights and restrictions with community 132.

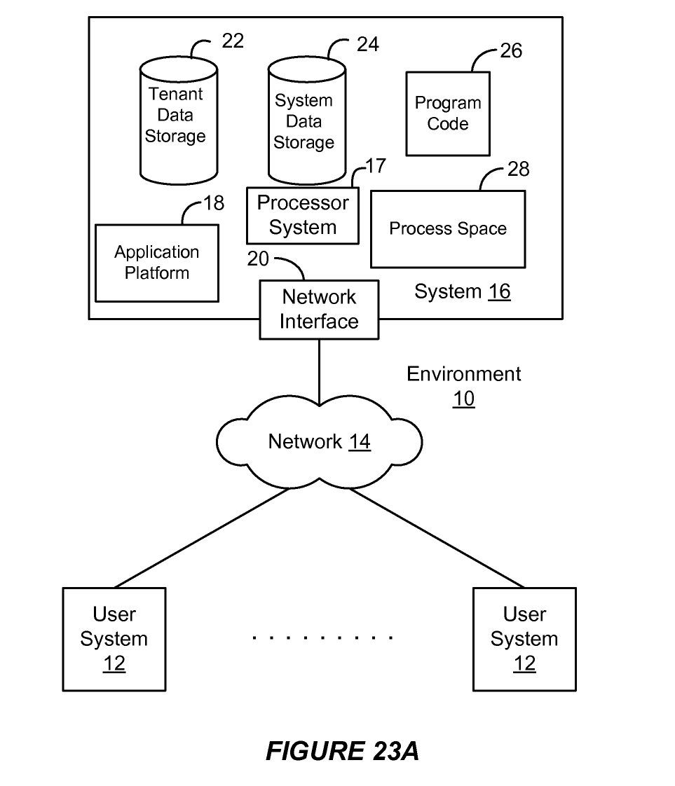

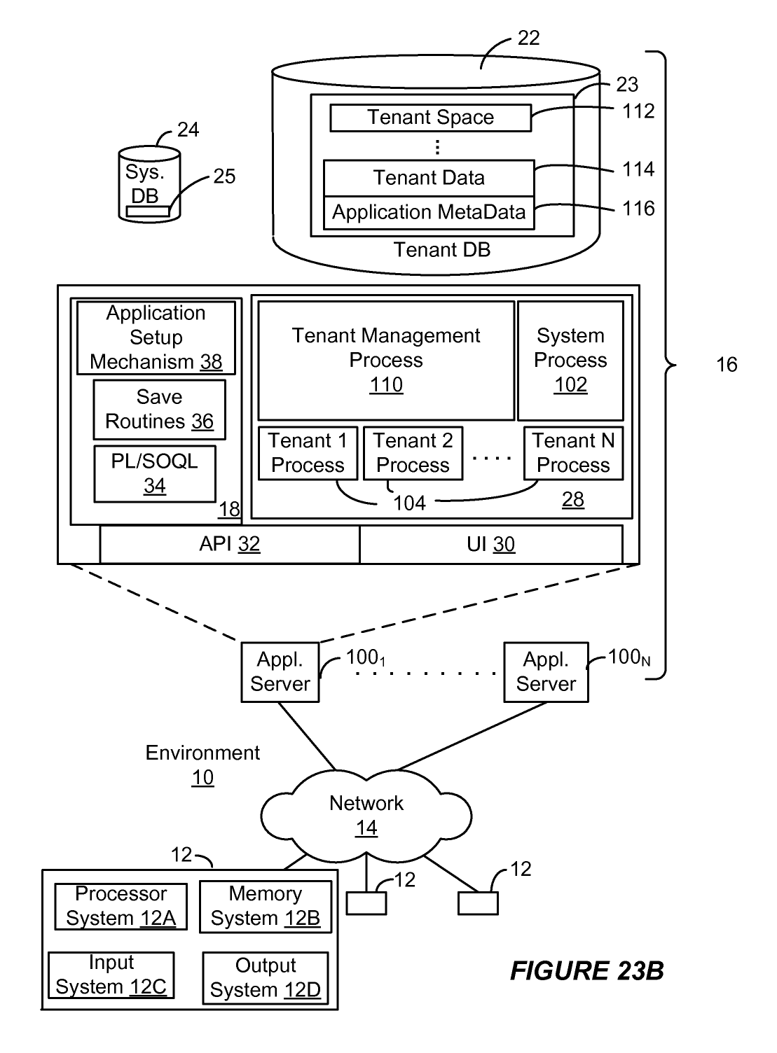

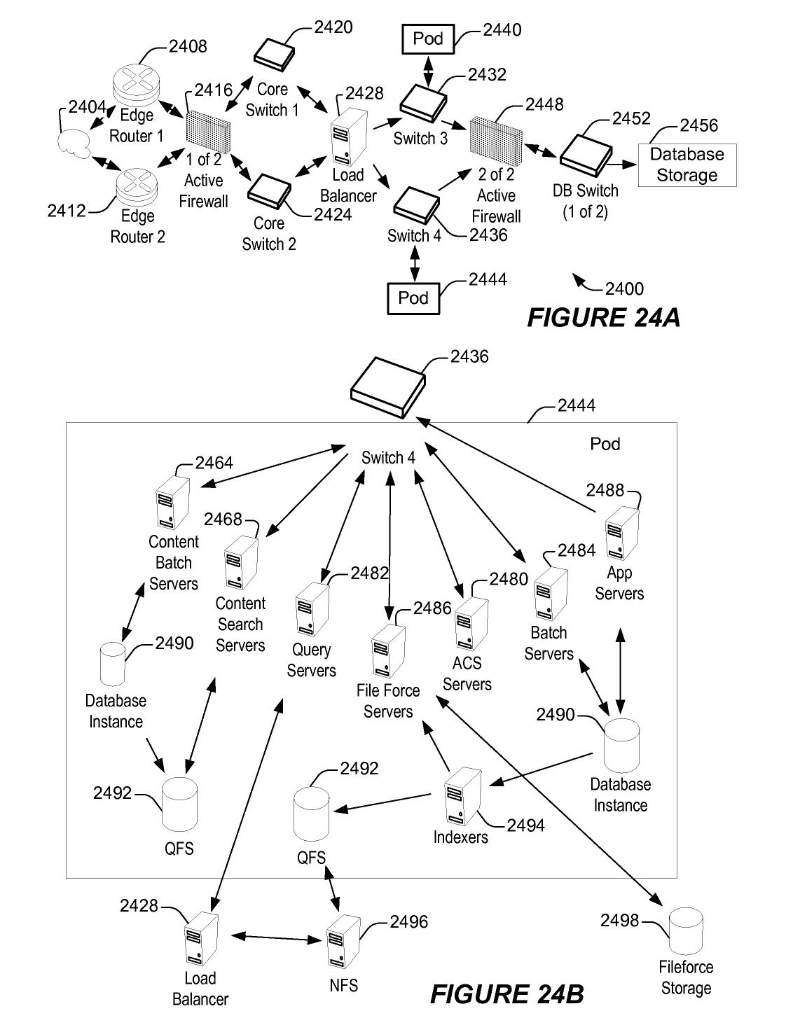

In one example, an app server 2488 in the on-demand service environment 2400 of FIGS. 24A and 24B described below includes one or more processors configured to perform part or all of blocks 204-224 of FIG. 2. In other instances, one or more other computing devices of FIGS. 24A and 24B such as a user system 12 and/or other servers retrieve, process, and exchange data to cooperate with app server 2488 to perform the blocks. When user input data is submitted from a user, such data can be received by a server over a data network from a user operating a user system 12 as shown in FIGS. 23A and 23B described below. In other instances, such data is received from a proxy server on behalf of a user or other data source. Various implementations of method 200 of FIG. 2 are possible, such that any of the servers described below with reference to FIG. 24B or other computing devices disclosed herein can be configured to receive, process, and output data in accordance with method 200.

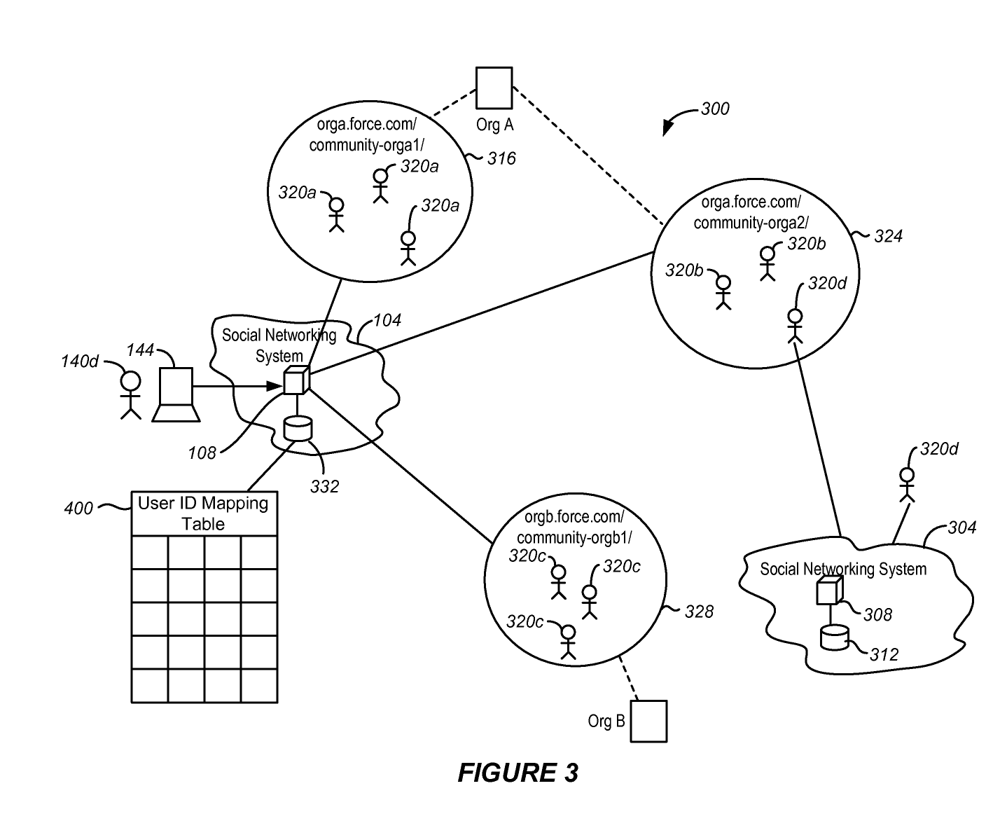

FIG. 3 shows a system diagram of an example of a social networking environment 300 with communities according to some implementations. While FIG. 1 shows a single social networking system 104 providing access to the various communities, the environment of FIG. 3 includes a second social networking system 304 in addition to social networking system 104 as generally described above. The social networking system 304 includes one or more servers 308 in communication with one or more storage mediums 312 configured to store user IDs, user profiles, and additional social network data appropriate for social networking system 304.

In the example of FIG. 3, social networking system 104 maintains a number of communities: community 316 of users 320a, community 324 of users 320b and a user 320d, and community 328 of users 320c. In this example, both communities 316 and 324 are maintained on behalf of the same organization, Org A. In this example, community 328 is maintained on behalf of Org B. In FIG. 3, social networking system 304 provides one or more social networking services to users having user accounts or profiles on system 304, including users 320d. In FIG. 3, a user ID database 332 of social networking system 104 maintains one or more user ID mapping tables 400 as an alternative or in addition to user ID tables 120 and 124 described above with reference to FIG. 1.

In FIG. 3, the user ID mapping table 400 can be used to identify one or more communities maintained by social networking system 104 of which a user 140d is a member. In addition, in the example of FIG. 3, the user ID mapping table 400 can be configured to identify any additional social networking systems such as system 304, at which user 140d may have a user ID. When a user 140d logs in to any community hosted at social networking system 104, the user ID mapping table 400 can be accessed to identify the user as a member of one or more other communities 316, 324 and 328 maintained by social networking system 104. Thus, the user can be automatically logged in, that is, without further input from the user, to the other communities of which the user is a member. In another example, the same user ID which a user submits to log in to his or her user account with an organization's intranet can be used to automatically log that user in to any communities maintained on behalf of the organization.

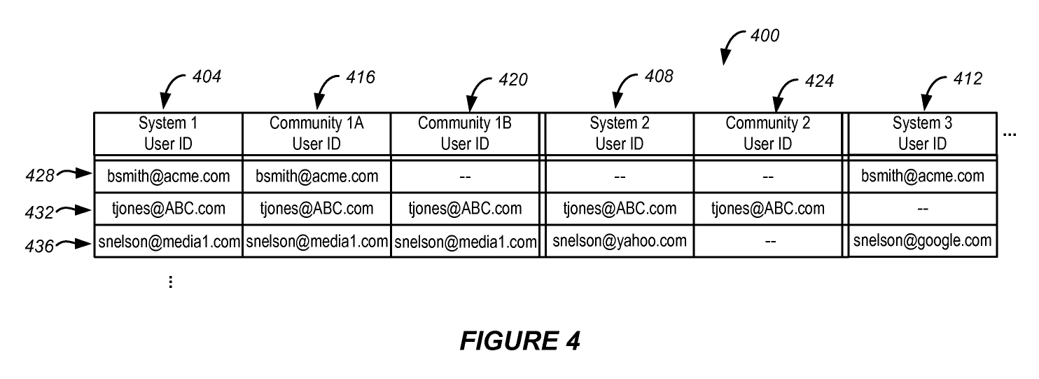

FIG. 4 shows an example of a user identity (ID) mapping table 400 identifying communities to which a user can be provided access, according to some implementations. In FIG. 4, the user ID mapping table 400 includes columns identifying any number of social networking systems and any communities maintained by such systems. In this example, table 400 identifies three respective social networking systems in columns 404, 408 and 412. Two communities identified in columns 416 and 420 are maintained by System 1, identified in column 404. Also, a community identified in column 424 is maintained by System 2 of column 408. In this example, System 3 identified in column 412 is a public system accessible by various users having accounts on such a system.

In FIG. 4, the user ID mapping table 400 can be configured to have rows identifying the user ID or IDs of a particular user used to gain access to any of the social networking systems and/or communities identified in the columns of table 400. A user can be able to log in to multiple different communities using the same single ID, for instance, in the form of a Chatter® user name, or in the form of an e-mail address used to access that user's account on LinkedIn° or Facebook®. In other instances, a particular user can have different IDs needed to log in or gain access to different communities and/or social networking systems. Thus, in this example, a user Bill Smith identified in row 428 has a user profile with System 1 and community 1A maintained by System 1. In this instance, the same e-mail address, bsmith@acme.com is stored in fields under columns 404 and 416. The same e-mail address, bsmith@acme.com, is used to access System 3 of column 412 as shown in row 428. Thus, in the case of Bill Smith, a single user ID in the form of Bill's e-mail address can provide access to various social networking systems and one or more communities maintained on behalf of such systems.

In FIG. 4, in row 432, a user, Tom Jones, has a first user profile with System 1 and a second user profile with System 2. In this instance, Tom Jones is also a member of communities 1A and 1B maintained by System 1 and community 2 maintained by System 2. As shown in row 432, the same e-mail address, tjones@ABC.com, is stored under the appropriate columns to identify Tom as a member of those social networking systems and communities. As shown in row 436, in some instances, it can be desirable to store different user IDs associated with the same user to allow that user to directly log in to different communities and/or social networking systems. In this example, Susan Nelson, a sales representative for Media One, Inc., has user profiles on Systems 1, 2 and 3 with different user IDs used to access each system. As indicated in row 436, one or more servers receiving one of Susan's IDs can use table 400 to log her in to System 1 using her e-mail address specific to System 1, in this case, snelson@media1.com.

Thus, returning to FIG. 3, when a user 140d provides a user ID to log in directly to a community hosted by social networking system 104 at the community URL, identification of the provided user ID in a row of user IDs in table 400 can allow one or more servers to retrieve other user IDs for the same user to automatically provide access to additional communities hosted at social networking system 104. Thus, for example, when a user logs in to a Burberry® community hosted at social networking system 104 of FIG. 3, that user can be automatically logged in to other communities 316, 324 and 328 using an appropriate mapping table such as table 400 of FIG. 4.

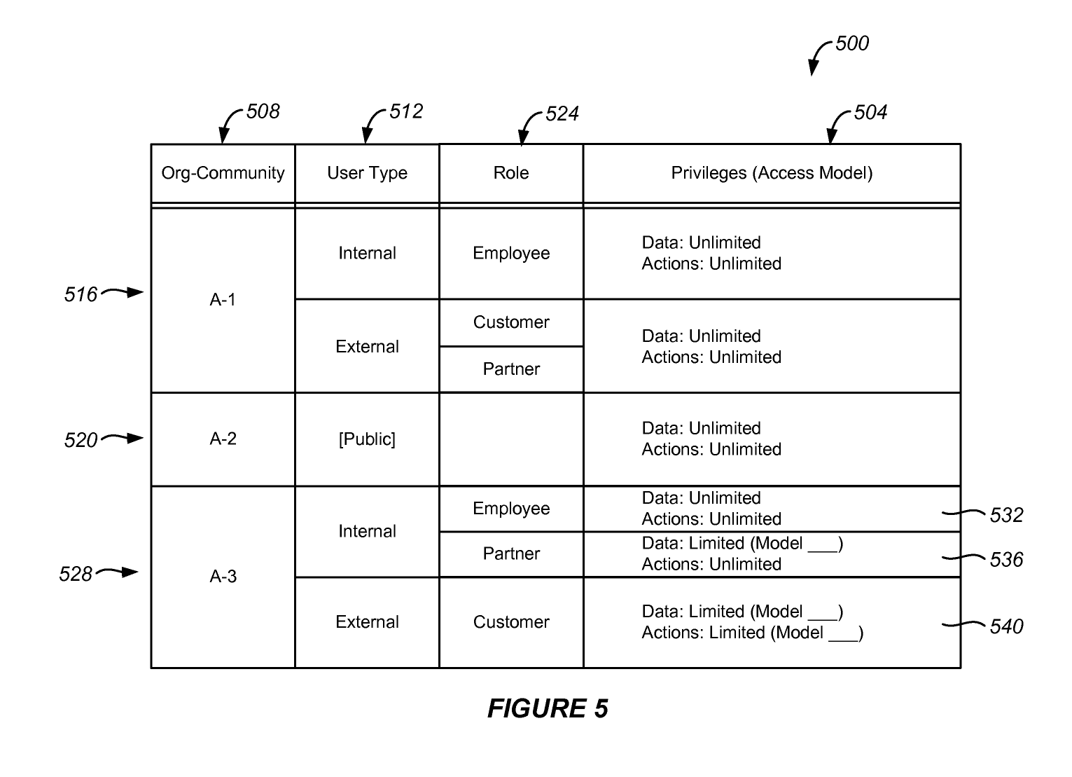

Returning to FIG. 1, various types of database tables can be structured to maintain appropriate privilege information in privileges database 116. FIG. 5 shows an example of a privileges table 500 identifying rights and restrictions of users to access data and initiate actions in one or more communities according to one or more attributes, according to some implementations. In FIG. 5, rights and restrictions can be defined and customized in terms of various attributes, including the identity of a particular organization on behalf of which a community is maintained, a particular community of which a user is a member, a type of user in the community, such as an internal user or an external user, as well as one or more roles a user in a community can have.

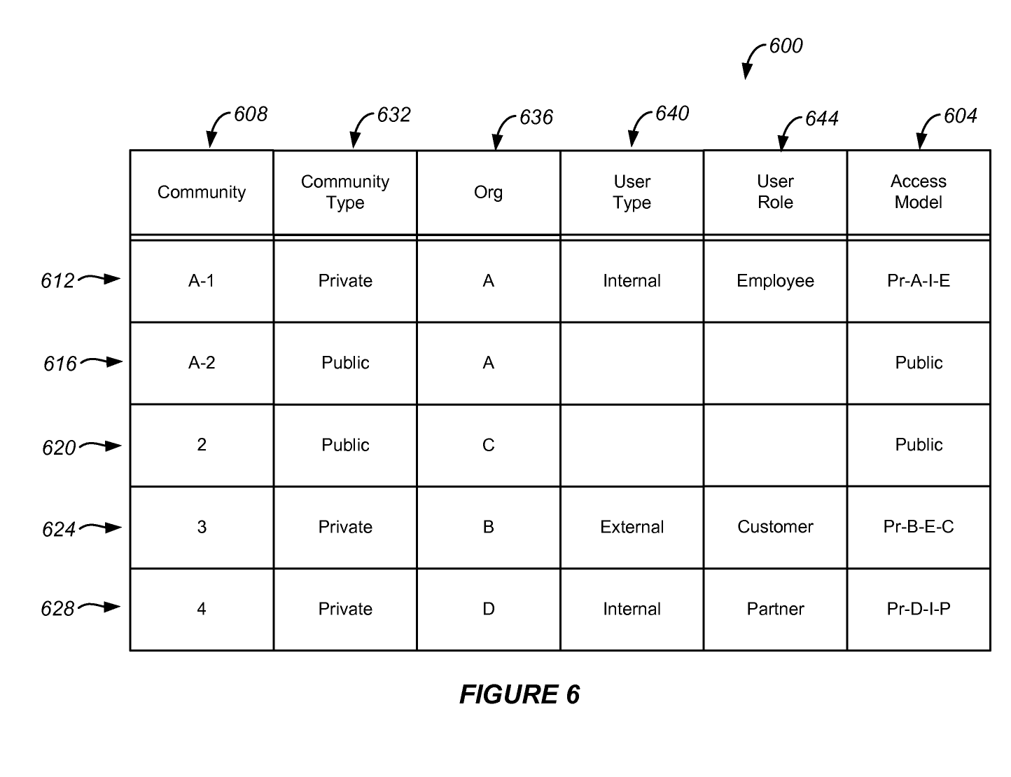

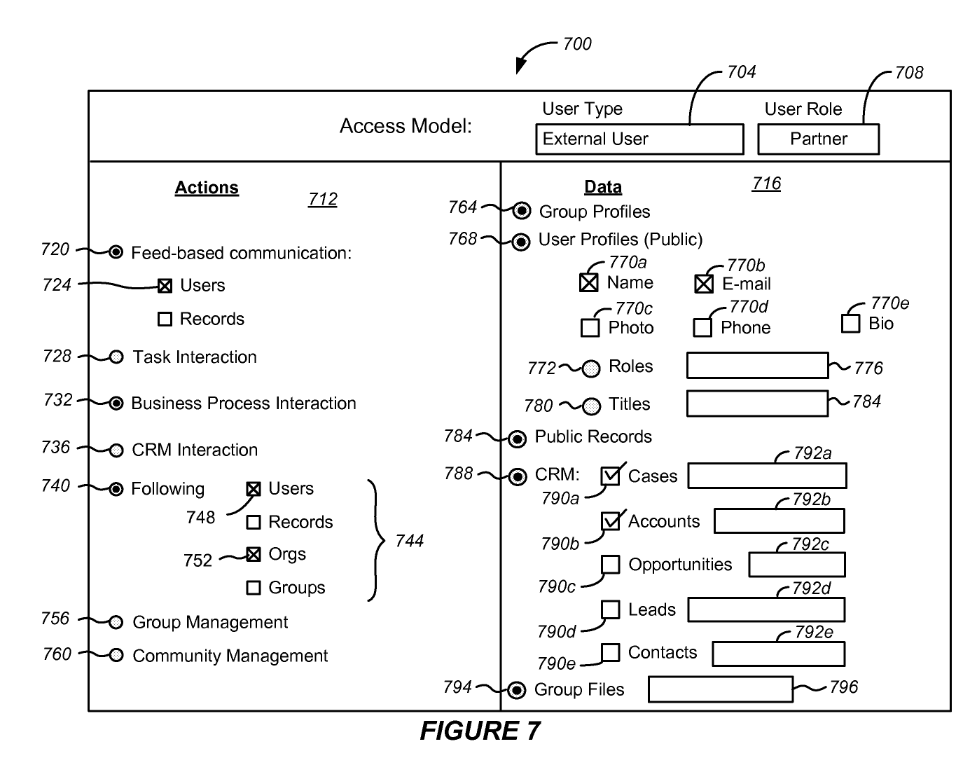

In FIG. 5, by way of illustration, privileges table 500 includes a privileges column 504 specifying whether a user's rights to access data and initiate actions are limited or unlimited according to various attributes as mentioned above. That is, the ability for a particular user to access and retrieve social network data and initiate various social networking actions can be defined as unlimited or limited in terms of one or more restrictions. Limited privileges with respect to social network data and/or actions can be defined on a per-attribute, per-user, per-data and/or per-action basis as described in greater detail below with reference to FIGS. 6 and 7. Examples of social network data with respect to which privileges can be uniquely defined and customized include particular names of records or types of records, particular user profiles or types of user profiles, particular statuses of user profiles, names of groups, particular types and statuses of groups, as well as CRM objects and various other constructs maintained by a social networking system. Examples of types of CRM objects include cases, accounts, opportunities, leads and contacts. Such CRM objects can be identified by name, type and/or status. Examples of particular social networking actions with respect to which a user can have unlimited or limited privileges include the ability to communicate with other users via one or more feeds, interact with particular records or types of records via one or more feeds, interact with one or more tasks, interact with one or more business processes, interact with CRM data, follow users, follow records, upload files, follow groups, join groups, create groups, follow organizations and create communities.

Returning to the example of FIG. 5, privileges can be defined and customized according to an attribute such as the identity of a particular organization and/or community with which a given user may be affiliated. For example, column 508 identifies communities A-1, A-2 and A-3, all of which are specific to Org A. With a particular community of a particular organization, as shown in column 512, a user's privileges with respect to data or actions can be categorized according to user type. For example, as shown in column 512, community 1 of Org A has both internal and external users, as shown in row 516. The “internal” or “external” type of a user can refer to the user's relationship with the community and/or organization identified in column 508. Thus, an internal user of community 1 of Org A may be an employee of Org A. In another example, different rights and restrictions are set up and maintained for internal and external users of community 1, regardless of which organization community 1 is affiliated with. As shown in row 520, some communities and Orgs have no specified user type or role, such as community 2 of Org A, which is a public community.

In FIG. 5, as shown in column 524, the privileges of a particular user can be further defined in terms of the user's role in a community and/or organization. Thus, in the example of row 516, employees of Org A have unlimited rights to access data and initiate actions in a social networking system in which community 1 is maintained. In the example of community 1 of Org A as shown in column 524 and row 516, other users having a customer or partner role, who are considered external users of Org A and community 1, also have unlimited rights to access and interact with data and initiate actions in social networking system 104, as shown in column 504. In this example, members of the public community 2 of Org A also have unlimited rights with respect to social network data and actions in the social networking system providing community 2, as shown in row 520 and column 504 of FIG. 5.

In another example, community 3 of Org A, as shown in row 528, has both internal and external users as shown in column 512. In community 3, internal users include both employees and partners of Org A. In community 3 of Org A, even though employees and partners are considered internal users of Org A, these different roles carry different privileges, as shown in fields 532 and 536. In field 532, employees have unlimited privileges with respect to social network data and actions. As shown in field 536, partners of community 3 of Org A have limited access to certain social network data and unlimited privileges to otherwise initiate actions in the social networking system providing community 3 on behalf of Org A. As described in greater detail below, when rights are restricted in some manner, that is, when privileges are limited as in the case of a partner's rights with respect to social network data in community 3 of Org A, an access model can be set up and customized to specify particular and restrictions for accessing and interacting with such data. Access models are described in greater detail in the examples below. Returning to FIG. 5, customers, who are considered external users of community 3 of Org A, as shown in row 528, have restrictions on their rights to access certain social network data and on their rights to initiate one or more actions, as defined in an appropriate access model, as show in field 540.

FIG. 6 shows an example of a privileges table 600 identifying different access models governing permissions of users to access data and initiate actions in one or more communities according to one or more attributes, according to some implementations. As shown in table 600, in some implementations, access models identified in column 604 can be differentiated from each other according to one or more attributes as described above with respect to FIG. 5 in addition to other attributes. In this example, various access models are configured according to the type of community such as private or public in column 632, the particular organization with which a community is affiliated in column 636, a user type in column 640, and a user role in column 644.

In FIG. 6, a community column 608 identifies any number of communities accessible through a social networking system. In this example, community column 608 identifies five communities in rows 612-628. In this example, communities A-1 and A-2 are both affiliated with Org A, community 2 is specific to Org C, community 3 is specific to Org B, and community 4 is specific to Org D. In the case of communities A-2 and 2, a user type and a user role in columns 640 and 644 are not specified. This is because communities A-2 and 2 are public communities, where users have the same rights and restrictions regardless of their type or role.

In FIG. 6, as shown in row 624, an access model in column 604 can be specific to community 3, which is a private community maintained on behalf of organization B, and where the rights and restrictions of the access model are specific to customers, who are external users of community 3. By the same token, as shown in row 628, a different access model can be assigned to partners of private community 4, where such partners are internal users of Org D. The table 600 of FIG. 6 is intended to show non-limiting examples of the different access models, which can be defined and customized according to the various attributes identified in columns 608, 632, 636, 640 and 644. Those skilled in the art will appreciate that various additional access models can be configured and maintained in additional rows of table 600, which provides a non-exhaustive listing of access models in column 604.

FIG. 7 shows an example of an access model customization window 700 as displayed in a graphical user interface (GUI) on a display device, according to some implementations. In FIG. 7, the access model window 700 allows a system administrator or authorized community member to customize the rights and restrictions a user has to initiate actions and retrieve social network data in one or more communities as mentioned above. In this example, a specific type of user can be specified in field 704, and a particular role of the user can be specified in field 708. Thus, customized selections described below can be stored on a suitable storage medium, for instance, in privileges database 116 of FIG. 1, to maintain customized rights and restrictions for particular user types and roles in a given community and/or organization.

In this example, access model window 700 includes an actions pane 712 with a list of actions available to external users who are partners, as indicated in fields 704 and 708. A data pane 716 identifies particular types of social network data, to which external users who are partners of a given community and/or organization can be granted access. In this example, “feed-based communication” selection 720 has been selected along with “users” sub-selection 724 to allow partners to communicate with other users using one or more feeds available to members of a given community. For example, clicking on selection 720 and sub-selection 724 allows a partner to post and comment on posts in a community feed. Selection 728, “task interaction”, allows one to determine whether partners will be allowed to interact with tasks otherwise accessible and viewable in a particular community. In this example, selection 728 has not been checked, thus preventing partners from interacting with such tasks. A “business process interaction” selection 732 has been activated, allowing partners to view and interact with business processes otherwise available to members of a given community. A “CRM Interaction” selection 736 has not been activated, thus preventing partners from interacting with CRM objects stored in the social networking system hosting the community. A “following” selection 740 allows a system administrator to grant rights to partners allowing them to follow one or more entities 744, such as users, records, organizations and groups. In this example, only the “users” and “orgs” sub-selections 748 and 752 have been selected, thus allowing partners to follow users and organizations but preventing partners from following records and groups. A “group management” selection 756 and a “community management” selection 760 can be selected to allow a particular user, a partner in this example, to have the right to create, manage and delete groups and communities. In this example, selections 756 and 760 have not been checked, thus preventing partners from having such privileges.

In FIG. 7, in data pane 716, a system administrator or other user can select particular data objects and types of objects to which a particular user, a partner in this example, can have read and/or write privileges in a community. In this example, “group profiles” selection 764 and “user profiles” selection 768 have been checked, thus allowing partners to view profiles of groups and users who have allowed their profiles to be publicly viewable. In this example, write privileges for such data are not available to anyone outside of a group leader or user owning the profile. Sub-selections 770a-770d can be selected to specify particular types of profile information to which a partner can have access. In this example, sub-selections 770a and 770b have been checked, allowing one to access a name and e-mail address of a public user profile, while selections 770c-770e have not been checked, thus preventing partners from accessing photos, phone numbers and biographical information of a user profile. In other sub-selections of user profiles, a roles selection 772 includes a data entry field 776 allowing a system administrator to specify one or more roles of users having profiles, which a partner can be granted access to view. Titles selection 780 similarly provides a data entry field 784 to specify titles of users having public profiles that a partner can be granted access to view.

In FIG. 7, selection 784 specifies whether a partner will have access to public records otherwise accessible through a given community. A “CRM” selection 788 includes sub-selections 790a-790e allowing a system administrator to specify in data entry fields 792a-792e the names of cases, accounts, opportunities, leads and/or contacts to which a partner shall have access. In this example, sub-selections 790a and 790b have been checked, with no names of cases or accounts specified in fields 792a and 792b. Thus, a partner will have general access to cases and accounts accessible to members of the particular community. By the same token, sub-selections 790c-790e have not been checked, thus preventing partners from viewing or otherwise interacting with opportunities, leads and contacts. Selection 794 can be checked to grant access to files of a particular group named in data entry field 796. In this example, this “group files” selection 794 has not been checked, thus preventing partners from accessing any such files stored or accessible to members of a particular group.

In FIG. 7, returning to user profiles selection 768 and sub-selections 770a-770e, a level of visibility of user profiles can be defined for partners of a community in terms of which types of information in users' profiles can be viewed. For example, it may be desirable in some instances that partners be able to access names and phone numbers, while in other instances, partners should be restricted from viewing any contact information other than the user's name.

As mentioned above, communities can be accessed at custom domains, which may include the name and/or brand of an organization with which the community is affiliated. In some instances, an organization actively managing or otherwise providing input to community pages may customize the particular domain name appropriately. Thus, in the example of FIG. 1, representatives of Acme, Inc. have customized the URL of community 128 to be acme.force.com/community-acme1/. In the example of FIG. 3, where communities 316 and 324 are both affiliated with Org A, community 316 can be accessed at the URL orga.force.com/community-orga1/, while community 324 can be accessed at the URL orga.force.com/community-orga2/. In FIG. 3, community 328 can have a URL customized by representatives of Org B as desired, for instance, to include a brand name of a product or service provided by Org B.

In FIGS. 1 and 3, when a user 140d is using an appropriate computing device 144 with a web browser program to navigate among the various available communities, some of the disclosed implementations provide for navigation from one community to another for the same and different organizations as a seamless experience for the user. Applying some of the disclosed techniques, cookies and web browsing sessions can be created and managed in a transparent and secure manner.

As described in greater detail below, in some implementations, during a browsing session, a user's computing device can be directed or redirected to appropriate login pages at selected times when appropriate for security purposes. For instance, a user 140d through the user's computing device 144 may request access to a community, which the user has not logged in to. In one example, in FIG. 3, a user may have logged in to community 324 but not community 328. In such cases, when the user attempts to click through a page provided at orga.force.com/community-orga2/that links to data maintained at community 328, that is at the URL orgb.force.com/community-orgb1/, security mechanisms can be implemented to ensure that the requesting user should be granted access to such data at community 328. In this and other various examples, the disclosed techniques provide for establishing, managing and checking browsing sessions between a user and one or more communities at appropriate times and, when desired for security purposes, prompting a user to enter credentials in the form of a user ID and/or password. In this way, using appropriate GUIs, users can select and retrieve data resources available through communities to which the user belongs and navigate with security mechanisms being triggered at appropriate times to confirm that the user should be granted access to such data.

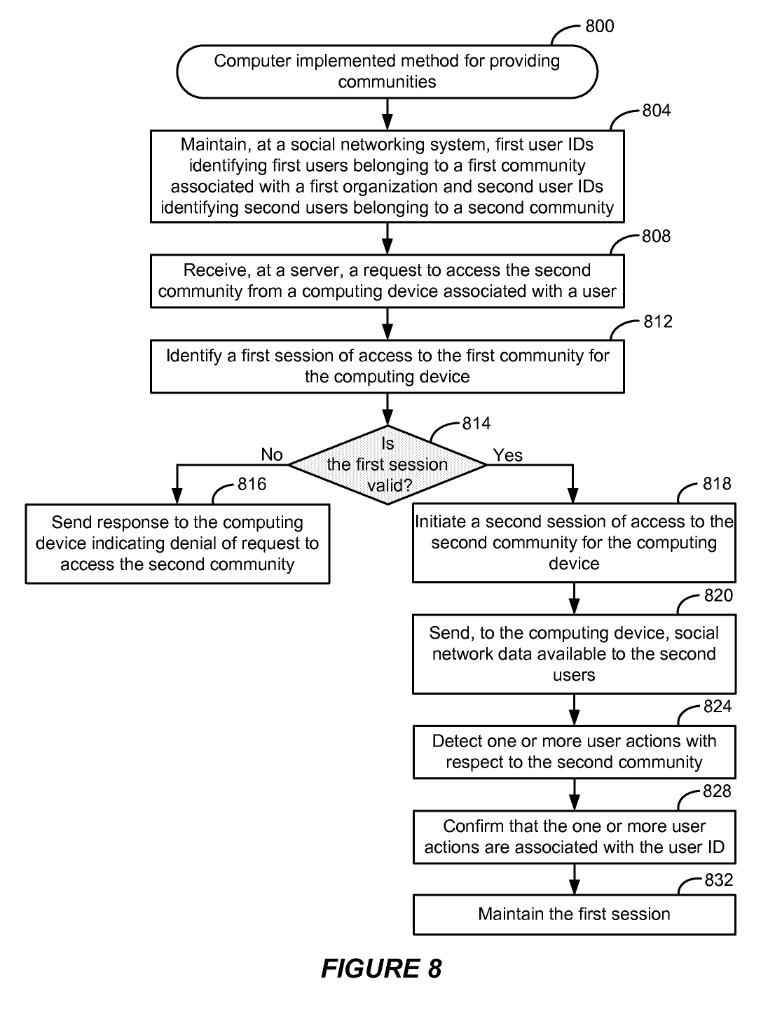

FIG. 8 shows a flowchart of an example of a computer implemented method 800 for providing communities in an online social network, performed in accordance with some implementations. In FIG. 8, at block 804, one or more database tables with user IDs identifying users belonging to particular communities can be maintained, such as tables 120 and 124 stored in user ID database 112 of FIG. 1 and user ID mapping table 400 stored in user ID database 332 of FIG. 3.

In the example of FIG. 8, a user such as user 140d of FIG. 3 has already established a browsing session with community 316, for instance, by logging into that community via one or more login pages provided to the user's computing device, for instance, at the orga.force.com/community-orga1/ sub-domain. In this example, after establishing this first session with community 316, thus providing computing device 144 with at least partial access to social network data accessible at community 316, at block 808, a server 108 in social networking system 104 receives a request from computing device 144 to access another community such as community 324, also operated on behalf of Org A. In response to receiving such a request, at block 812, a server 108 in social networking system 104 identifies the first session, for instance, by reading a cookie identifying the first session that was delivered to user 140d's computing device 144 when the first session with the community 316 was established.

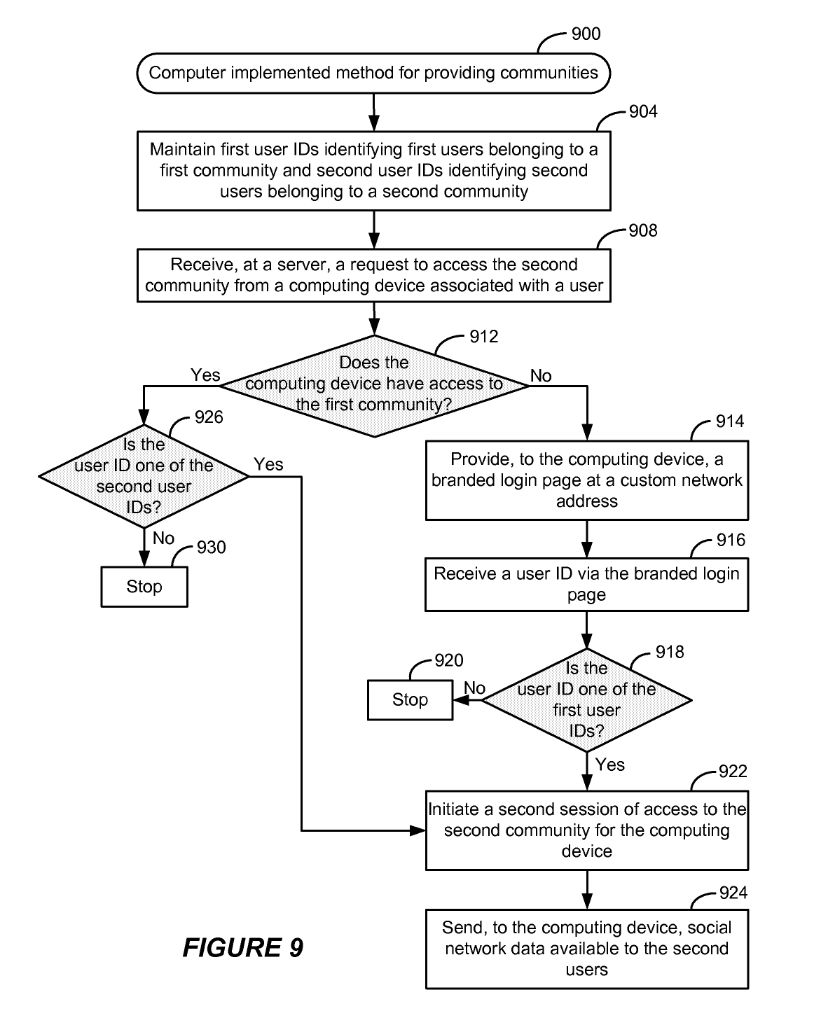

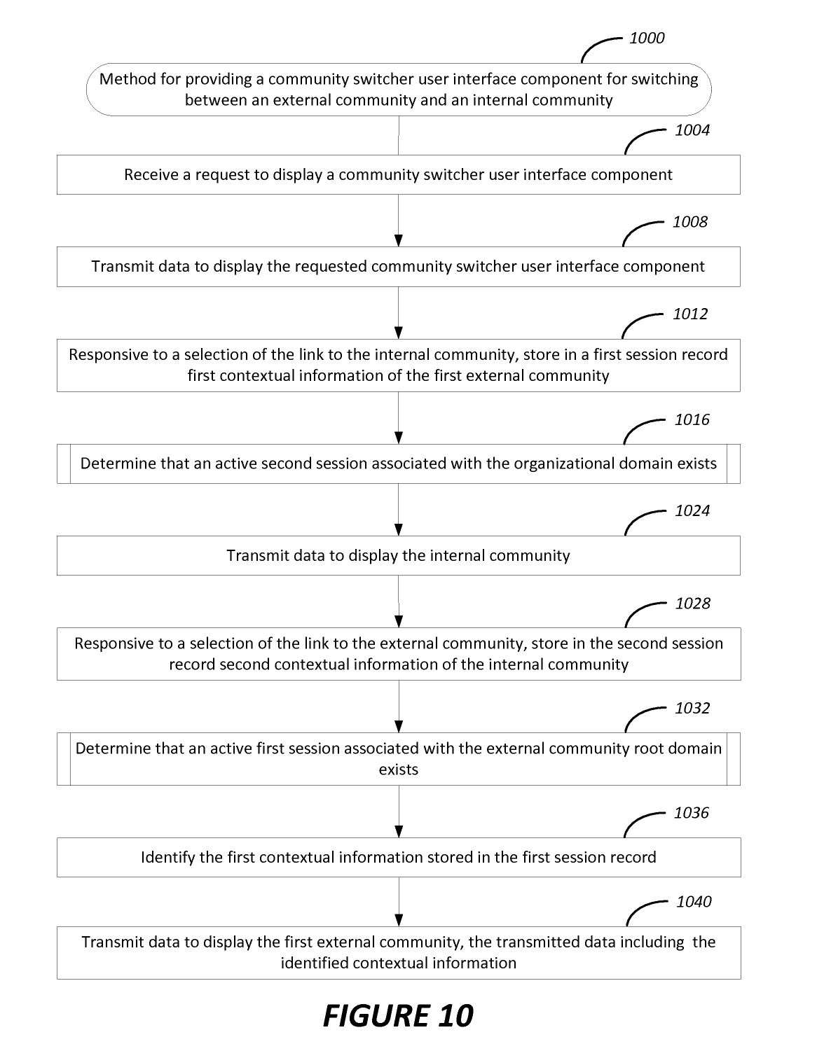

In FIG. 8, at block 814, after the first session has been identified, at block 814, a server 108 in social networking system 104 is configured to determine whether the first session is still valid. One or more processing operations can be performed at block 814 to check for one or a combination of conditions indicating that the first session is valid, as described in greater detail below with reference to FIGS. 9 and 10. At block 816, if the session with community 316 has timed out or is otherwise invalid, the request to access the second community is denied, for example, by delivering an appropriate response to computing device 144.

Returning to block 814, when the first is determined to be valid, at block 818, the request can be granted; that is, a second browsing session between computing device 144 and community 324 can be initiated. One or more databases at social networking system 104 can be configured to store and maintain identifications of sessions between a given user's computing device and any number of communities accessible via social networking system 104. In some instances, as additional sessions are initiated for a user's computing device after determining that one or more valid sessions exist between that user's computing device and other communities, the identifications of the additional sessions can be linked, for example, in a parent-child hierarchy. For example, one session can be identified as a parent or child of another session determined to be valid at block 814. The parent-child hierarchy represents one of various examples for identifying and managing concurrent sessions that a user may establish with various communities accessible through a social networking system. In other examples, a database table similar to user ID mapping table 400 of FIG. 4 can be maintained, with fields under the respective system and community columns 404-420 indicating whether a session is active.

In FIG. 8, at block 820, since a session with community 324 has been established, social network data accessible through community 324 can be delivered to the user's computing device 144 upon request, that is, after determining that the user 140d has the appropriate privileges to access such data, as indicated by an access model or other definition of user rights and restrictions for community 324 as described above.

In some instances, it can be desirable to maintain one or more browsing sessions in response to user activity with respect to a given community. That is, as time passes and there is inaction on the part of a user 140d in any of the various communities with which the user has established a browsing session, activity on one of the communities can refresh sessions in the other communities. Thus, at block 824, by way of example, when a user takes an action such as following another user or subscribing to a record of community 324, such an action can be detected. After confirming at block 828 that such user action is requested by user 140d, for example, by checking one or more cookies stored at computing device 144, at block 832, sessions with other communities such as community 316 can be maintained. For instance, when a timeout condition is implemented at community 316, activity in community 324 can cause the clock on which the timeout condition is based to be reset.

FIG. 9 shows a flowchart of an example of a computer implemented method 900 for providing communities in an online social network, performed in accordance with some implementations. In FIG. 9, at block 904, one or more database tables are maintained to identify users who are members of various communities as generally described above at block 804 of FIG. 8. In this example, the lists of user IDs identify communities associated with different organizations. Thus, for example, as described above with reference to FIG. 3, a user ID mapping table 400 can identify communities 324, 328 and 336 in addition to community 316.

At block 908, a server 108 in social networking system 104 receives a request to access community 324, 328 or 336 from computing device 144 operated by user 140d. For example, a user browsing a feed provided by community 316 may see a feed item including a link to a file stored for members of community 324 or 328. In another example, a user browsing such a feed in community 316 may wish to view a user profile of a user who submitted a post to the feed of community 316. The request of block 908 can be in the form of a mouse click or other selection made in a GUI to access data of another community or take some other action with respect to the other community.

At block 912, in response to receiving such a request at block 908, a server in social networking system 104 is configured to determine whether the user's computing device 144 has access to another one of the communities. One or more conditions can be checked to make this determination at block 912. For example, a server 108 can check whether a browsing session exists between the user's computing device 144 and community 316. If such a session exists, the server can attempt to authenticate that session, for example, using a session cookie previously stored at the user's computing device 144 when the session with community 316 was established.

In some implementations, users can log in to multiple communities affiliated with the same organization as desired to establish respective sessions between the user's computing device and those communities. In some instances, a cookie is issued for the root domain of the organization, regardless of how many communities affiliated with that organization that the user has established sessions with. That is, in some instances, multiple sessions with different communities affiliated with the same organization can be identified by a single root domain cookie identifying the organization. Thus, in the example of FIG. 3, Org A has at least two communities, community 316 and community 324. While user 140d can establish a separate session with each community 316 and 324, in some implementations a cookie is only issued identifying the root domain, orga.force.com, which is applicable to both communities 316 and 324. Thus, in the example where a user has a session established with community 316 and is requesting access to community 324, a server 108 of social networking system 104 checks whether a cookie identifying orga.force.com has been issued to the user's computing device 144. If the cookie indicates that the session with community 316 is valid, method 900 can proceed to check other conditions, at block 926, such as whether the user is identified in a table of user ID database 332 as a member of the community to which the user has requested access, in this case community 324. When such additional condition(s) is satisfied, method 900 can proceed to block 922 described below. At block 926, when the requesting user is not identified as a member of community 324, the user is denied access, for instance, by a server 108 sending an appropriate message for display in a GUI on the user's computing device 144.

Thus, for example, returning to block 912, when an external user has already logged in to community 316 and attempts to access a resource at community 324, session management code can be executed at a server 108 to identify a valid session with any community at the shared root domain of Org A, orga.force.com, as indicated by a cookie on the user's computing device 144. When a valid session with orga.force.com is identified, at block 926, the server confirms that the user has rights to access the requested resource at community 324 by confirming that the requesting user is a member of community 324.

Returning to block 912, when it is determined that computing device 144 does not have access to community 316, a server 108 can provide the user with an opportunity to log in to community 316. Thus, the server can provide a branded login page at a custom network address to be loaded by the browser program operating on computing device 144, at block 914. The branded login page can include branding information identifying community 316 and a prompt for a user ID and password to gain access to community 316. For instance, the login page provided at block 914 can include product or service names of organization A and community 316. The login page at block 914 can be served from an appropriate custom URL such as the orga.force.com/community-orga1/ subdomain. Such a login page can serve as an entry point to community 316 for both internal and external users, as described in greater detail in the examples below.

In FIG. 9, at block 916, the user ID to access community 316 is received from computing device 144. At block 918, a server 108 at social networking system 104 determines whether the received user ID is one of a list of user IDs of members of community 316. If the user ID is not identified at block 918, processing can be terminated at block 920. Returning to block 918, if the user ID received at block 916 identifies a member of community 316, at block 922, a browsing session providing access to the requested community 324 is established for computing device 144. Thus, at block 924, when a user 140d requests social network data and/or actions available to members of community 324, appropriate data can be transmitted from a server 108 in social networking system 104 to computing device 144.

While the examples described above in relation to FIG. 9 are in terms of different communities maintained on behalf of the same organization, the same techniques can be applied to initiate, maintain and check the validity of browsing sessions established between a user's computing device 144 and various communities accessible through a social networking system 104, including communities maintained on behalf of other organizations. Database tables identifying and storing multiple sessions at a given time between the user's computing device 144 and the various communities, for instance, as identified in FIG. 3, can be provided in a storage medium of social networking system 104. Thus, one or more servers in a given social networking system 104 can identify and manage user browsing sessions with communities maintained on behalf of various organizations by expanding the number of cookies issued to a computing device to identify such sessions. In situations where multiple organizations and communities of such organizations are provided, separate cookies can be issued to identify individual sessions with particular communities or identify groups of sessions according to the organization on behalf of which the communities are maintained.

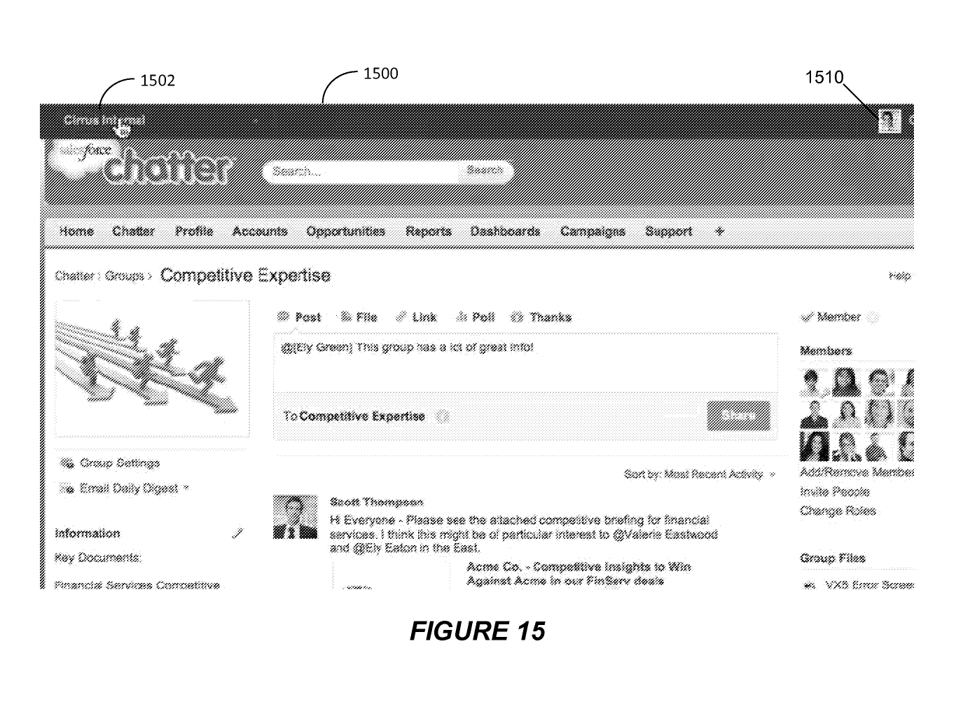

FIG. 10 shows a flowchart of an example of a computer-implemented method 1000 for providing an internal user a community switcher user interface component for switching between an external community that the internal user is a member of and an internal community, where the internal community is established at an organizational domain, and the external community is established at an external community root domain, performed in accordance with some implementations. FIG. 10 is described with reference to the examples of FIGS. 15-18.

In FIG. 10, at block 1004, a server 108 in social networking system 104, as described above in FIG. 1, receives a request to display a community switcher user interface component. In some implementations, the request may be made by a user 140d clicking on a link in the user interface at a computing device 144. In another implementation, the request may be made by the user 140d entering a keyboard shortcut for displaying the community switcher user interface component.

In FIG. 10, at block 1008, the server 108 transmits data to display the requested community switcher user interface component. The community switcher user interface component includes links to one or more internal communities and links to one or more external communities that the internal user is a member of. In one implementation, the community switcher may include one link to an internal community, a link to an external customer community, and a link to an external partners community.

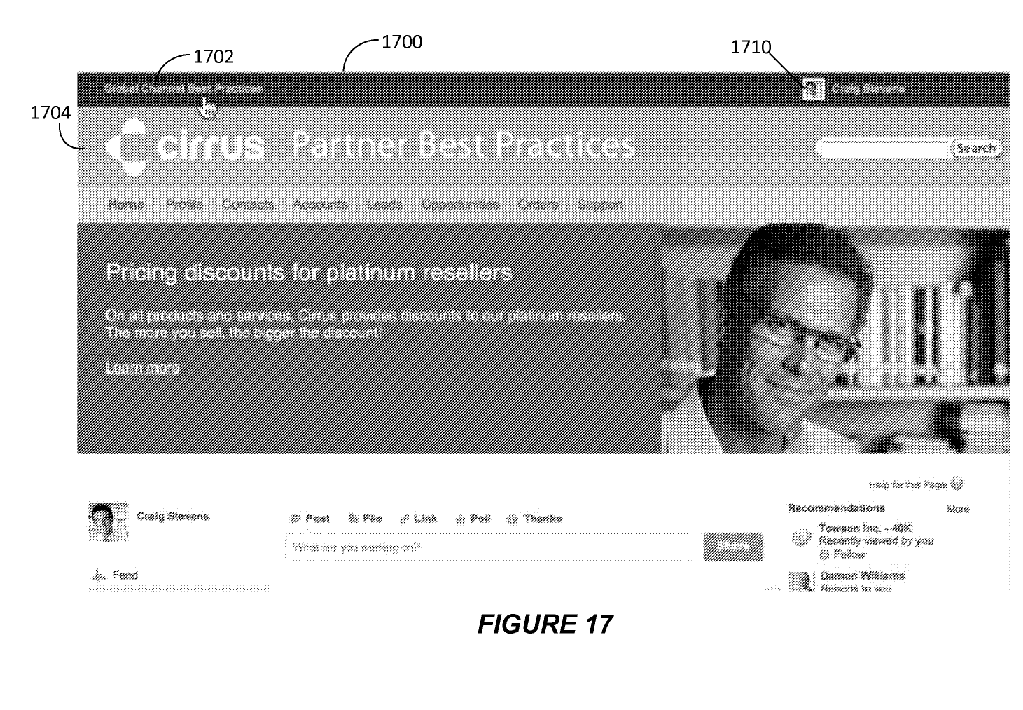

FIG. 17 shows an example of an external community presented in a user interface, according to some implementations. The user interface may be presented at a display device of a computing device 144. An internal user logged into a social networking system 104 may be presented with this user interface 1700 either initially or after some activity in the social networking system 104. The internal user may click on the closed community switcher user interface 1702 to open the community switcher user interface component.

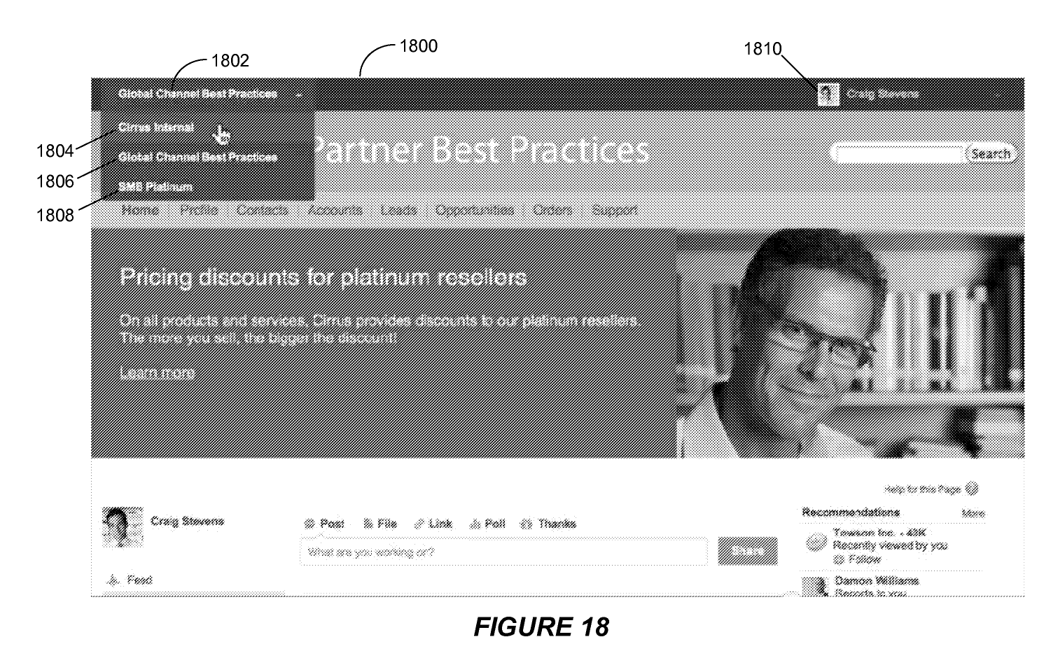

FIG. 18 shows an example of a community switcher user interface component presented in a user interface of an external community, according to some implementations. After the user clicks on the closed community switcher user interface component, the server 108 may respond by causing the open community switcher user interface component 1802 to be displayed at the computing device 144. As illustrated in FIG. 18, the community switcher 1802 may include a link to the internal community 1804 of the social networking system 104, and the switcher 1802 may also include links to external communities 1806 and 1808. In another implementation, the links to the communities may be a series of graphical representations that the user may click on. In the implementation depicted in FIG. 18, the “Global Channel Best Practices” community and the “SMB Platinum” community are external communities that the user 140d is a member of Once the community switcher user interface component 1802 is open, it may allow a user to switch from the community that is currently open in the user interface 1800 to another community that is listed in the community switcher 1802.

Further, the community switcher 1802 may also include an indicator indicating the community that the user is currently viewing. The indicator may take the form of highlighting the link of the community currently being viewed, or a graphical indicator adjacent to the link of the community.

In some implementations, when an internal user is viewing the community switcher 1802, the first item 1804 in the switcher is the internal community, as is the case in FIG. 18. The sort order of the rest of the communities may be alphabetical by community label, as depicted by external community links 1806 and 1808. In another implementation, the sort order for the external communities may be based on when the community was last accessed. In yet another implementation, the sort order for the external communities may be by the status of the external community.

In some implementations, the community switcher user interface component may display a status indicator for the communities 1804, 1806, 1808. The status of a community may be “Under Construction”, meaning the community is still under construction and in the process of being designed and setup, and may not be accessed by users except for an administrator constructing the community. The status of a community may be “Offline”, meaning the community has been constructed, but is currently offline, meaning members cannot log into the community and access resources of that community. Also, the status of a community may be “Online”, meaning the community has been constructed and members of the community may access the community. In some implementations, when a community has an “Online” status, there may be no indicator displayed next to the link to the community.

When the sort order for the external communities in the community switcher 1802 is by status, the community switcher 1802 may display the “Online” communities first, followed by the “Offline” communities, followed by the “Under Construction” communities. In other implementations, the sort order may be any permutation of the statuses of the communities. Furthermore, depending on the status of the user 140d, the user may not be able to see the full list of communities depending on the statuses of the communities. For example, an administrative user with the ability to create and construct new communities may be able to see all of the communities that he is a member of, including the under construction communities. A portal user may be able to see online communities that he is a member of and offline communities that he is a member of. However, in some implementations, a portal user may not be able to see the internal community or any communities that are under construction. An internal user or employee may be able to see the internal community, any online communities that he is a member of, and any offline communities that he is a member of. For both the portal user and the internal user, the offline community, though displayed, may be disabled so that the user may not access the offline community. For the administrative user, the offline community may be enabled, allowing the administrative user to manage the offline community.

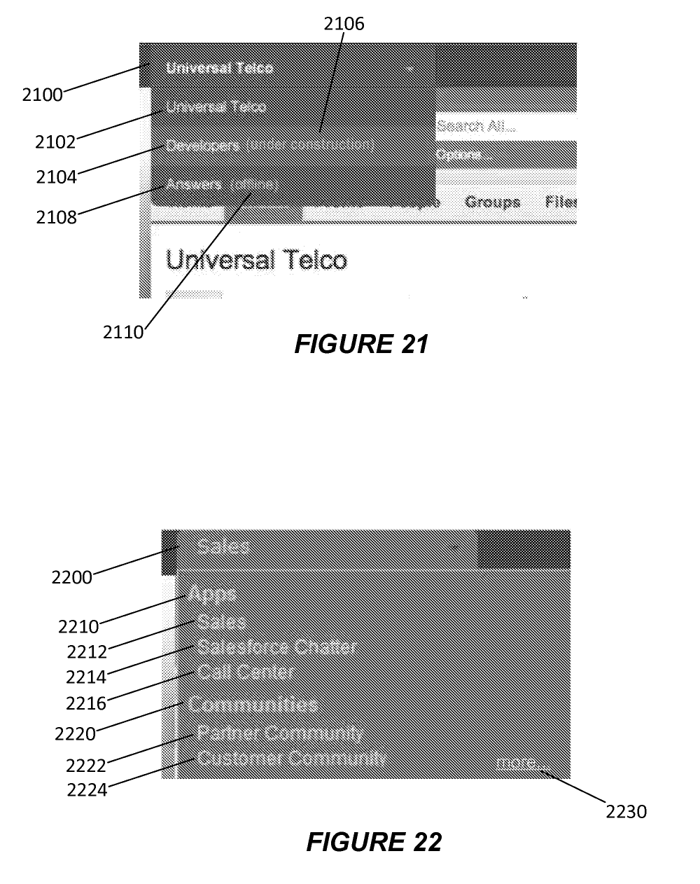

FIG. 21 shows an example of a community switcher user interface component, according to some implementations. The community switcher user interface component 2100 includes a link for an internal community 2102, and two links for the Developers and Answers external communities 2104, 2108. The status indicator 2106 for the Developers community indicates that the Developers community is under construction. The status indicator 2110 for the Answers community indicates that the Answers community is currently offline. In this implementation, the absence of a status indicator next to the link to the internal community 2102 indicates that the Universal Telco internal community is online. Because the user is an administrative user, each of these communities is visible to the user, and each of the links are active and will allow the administrative user to access the communities.

In yet another implementation, the link to the internal community may be displayed in the community switcher under a first category of links, and the links to the external communities may be displayed under a second category of links in the community switcher.

FIG. 22 shows an example of a community switcher user interface component, according to some implementations. In this example, the external communities 2222, 2224 are listed under a “Communities” header 2220, and the internal community 2214 is listed under an “Apps” header 2210 that includes other applications 2212, 2216 of the social networking system 104. This may allow a user to quickly discern which links are for external communities and which links are for internal communities and applications. In some implementations, where there is a large list of communities and apps, a “more” link 2230 may be used to reveal the entire list of communities and applications.

In some implementations, the organizational domain and the external community root domain may be hosted by the same server 108 of the social networking system 104. As an example, the organizational domain may be “na1.salesforce.com”, and the external community root domain for hosting Acme external communities may be “acme.force.com”. The Acme customer community may be hosted at “acme.force.com/customercommunity”. In this implementation, both na1.salesforce.com and acme.force.com may be hosted by the same server 108 of the social networking system 104. In other implementations, the same server 108 of the social networking system 104 may host another external community root domain for an external community of another organization, say Org A. The domain for the community may be “orga.force.com/customercommunity” and the community may be hosted by the same server 108 of the social networking system 104. FIG. 1 presents an example of a server 108b hosting external communities of three different organizations: Org A, Org B, and Org C. This may allow the server to maintain the sessions for the external communities of the different organizations and allow the user to use the community switcher 1802 to switch among the external communities.

Returning to FIG. 10, at block 1012, the server 108 of a social networking system 104 performing method 1000 receives a selection of a link to the internal community. In some implementations, the selection of the link to the internal community may be received from an internal user navigating an external community who wishes to switch to the internal community to research a topic or collaborate with other internal users on the internal community. In the above example of Eric, the Acme employee, Eric may have opened a case in an external customer community and now wishes to switch to the internal community to post a question regarding the customer's question or to search through a knowledge database for articles pertaining to the customer's question. Eric may then click on the community switcher in the header of the user interface, causing the community switcher user interface to appear, and click on the link to the internal community to switch to the internal community.

At block 1012, responsive to the selection of the link to the internal community, contextual information for the external community is first stored in a session record in a database. The session record contains session information for the session associated with the external community. The contextual information is stored in the session record before switching away from the external community to the internal community, so that when the user switches back to the external community at a later time, the contextual information may be restored when the external community is displayed.

In some implementations, the contextual information may include information associated with one or more object records stored in a database, wherein the information is what is being displayed in the external community when the request to switch to the internal community is made. The session record may be stored in database 332 of the social networking system 104 of FIG. 3 or in either the user ID database 112 or the Privileges database 116 of the social networking system 104 of FIG. 1. Examples of contextual information may include an information feed displayed in the external community user interface, or a contextual sidebar with knowledge articles, or the results of a search in the external community, or a partially composed social media message. Other examples of contextual information include open chat sessions with other users, selected sort orders on feeds or lists, or the currently open social networking group. This contextual information may be stored in the session record for the session associated with the external community, so that the contextual information may be displayed when the user switches back to the external community.

In FIG. 10, at block 1016, the server 108 of the social networking system 104 performing method 1000 determines that an active session associated with the organizational domain exists. In some implementations, the server 108 does this by determining whether an active session record associated with the organizational domain and with the user exists in the database.

In some implementations, the session associated with the organizational domain has a parent-child relationship with the session associated with the external community root domain, where the session for the internal community is the parent session and the session for the external community is the child session.

In yet another implementation, the session information for the parent and child sessions include a user ID associated with the user, a session expiration time, and a domain. The user ID may uniquely identify the user 140d of the social networking system 104 when determining whether the user 140d has an active session at the domain. The session expiration time may determine the time at which the session corresponding to the session information expires. The server may also renew the session expiration time from time to time, which will be discussed below. When the session expiration time of a session is prior to the current time, the session is expired and inactive. The domain of the session information determines what domain or subdomain the user associated with the session should have access to. For example, if the domain is “na1.salesforce.com”, which is the organizational domain for the internal community, then as long as the session expiration time is later than now, the user associated with the user ID of the session has an active session in the internal community. Similarly, if the domain of an active session is “acme.force.com”, then the user associated with the session will have an active session at all of the external communities hosted at “acme.force.com”, such as, for example, “acme.force.com/customercommunity” and “acme.force.com/partnercommunity”.

In some implementations, the session record containing the session information may be stored in the database 332 of FIG. 3 or either the user ID database 112 or the privileges database 116 of the social networking system 104 of FIG. 1.

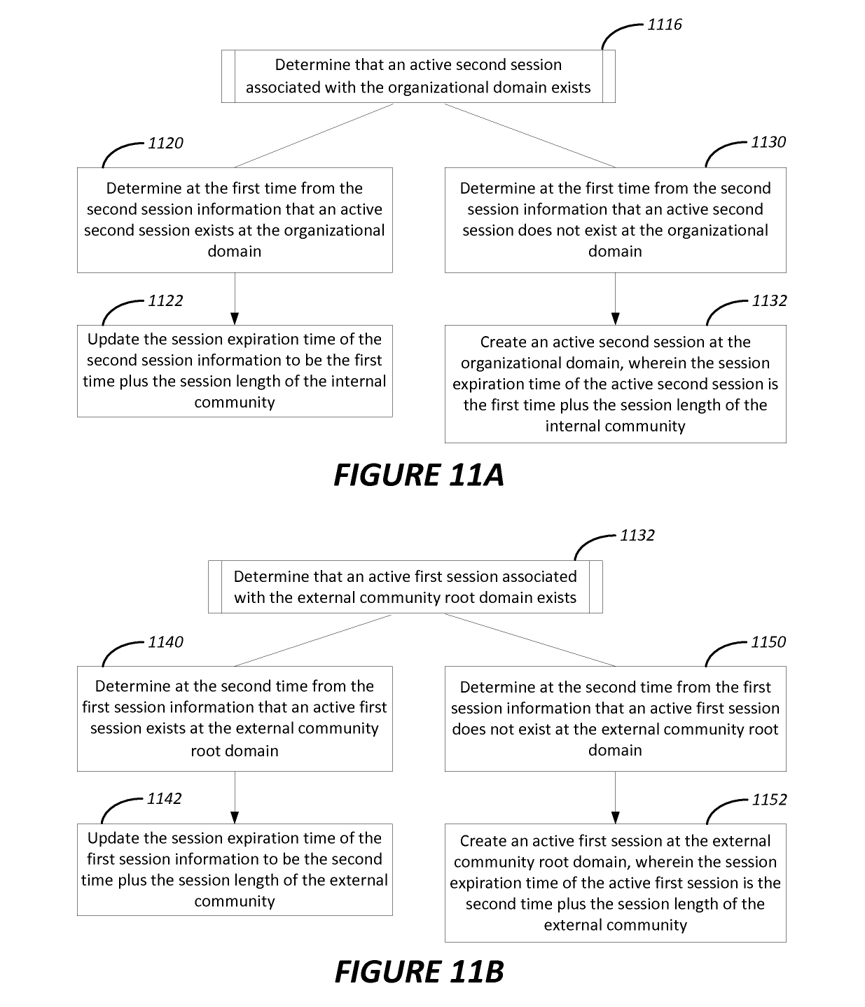

Returning to block 1016, block 1016 can be implemented as various methods described below with reference to FIG. 11A.

FIG. 11A shows a flowchart of two examples of a computer implemented method 1116 for determining that an active second session associated with the organizational domain exists, performed in accordance with some implementations. In FIG. 11A, at block 1120, the server 108 of the social networking system 104 performing method 1116 determines from the session information of the second session that an active second session exists at the organizational domain. In some implementations, the session information is stored in a session record in a database that is accessible by the server 108. The server 108 may determine whether the session record associated with the organizational domain and the user exists, and whether the session expiration time is before or after the current time. With this information, the server 108 may determine whether an active second session exists at the organizational domain.

In FIG. 11A, at block 1122, the server 108 updates the session expiration time of the session information of the second session to be the current time plus the session length of the internal community. In some implementations, when an active session for the internal community already exists and a request is made to switch to an external community, the server refreshes the session associated with the internal session by updating the session expiration time of the active session associated with the internal community.

Returning to FIG. 11A, at block 1130, the server 108 determines from the second session information that an active second session does not exist at the organizational domain. As described in block 1120, the server 108 may determine from the database that stores the session records whether a session associated with the organizational domain and with the user exists, and whether that session has expired.

In FIG. 11A, at block 1132, the server 108 creates an active second session at the organizational domain. The session expiration time of the second session is the first time plus the session length of the internal community. The domain of the second session may be set to the organizational domain and the user ID of the second session may be set to the user ID of the internal user.

Returning to FIG. 10, at block 1024, the server 108 of the social networking system 104 performing method 1000 transmits data to the computing device 144 to display the internal community on a display of the computing device 144 to a user 140d.

FIG. 15 shows an example of an internal community presented in a user interface, according to some implementations. An internal user logged into a social networking system 104 may be presented with this user interface 1500 either initially or after some activity in the social networking system 104. The internal community may include a profile image 1510 indicating the user that is currently logged into the community. Moreover, the internal community may display a closed community switcher user interface component 1502 indicating the identity of the currently open community. The internal user may click on the closed community switcher user interface 1502 to open the community switcher user interface component. In the Acme example, the Acme employee may use the internal community to research his case, discuss the case with other Acme employees, post a question to the community, or write up a knowledge article regarding the case.

In FIG. 10, at block 1028, responsive to a selection of the link to the external community, the server 108 of the social networking system 104 performing method 1000 stores contextual information of the internal community in a session record in a database. The session record contains session information for the internal community and is associated with an organizational domain, a user ID, and a session expiration time.

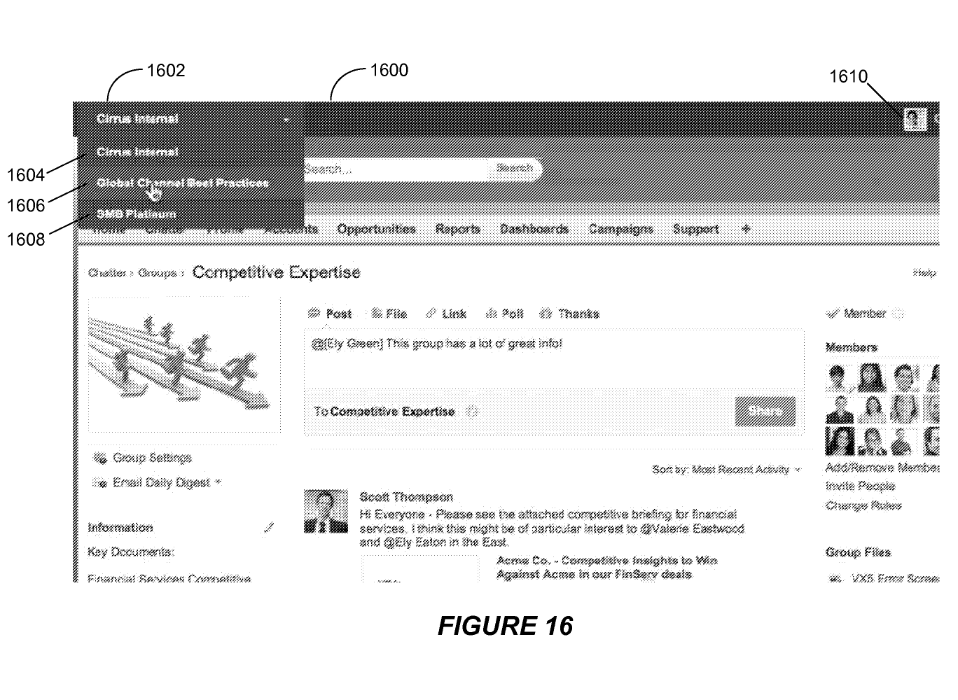

FIG. 16 shows an example of a community switcher user interface component presented in a user interface of an internal community, according to some implementations. After the user clicks on the closed community switcher user interface component, the server 108 may respond by causing the open community switcher user interface component 1602 to be displayed at the computing device 144. As illustrated in FIG. 16, the community switcher 1602 may include a link to the internal community 1604 of the social networking system 104, and the switcher 1602 may also include links to external communities 1606 and 1608. Once the community switcher user interface component 1602 is open, it may allow a user to switch from the community that is currently open in the user interface 1600 to another community that is listed in the community switcher 1602.

In the Acme example, the user, having switched from the external Acme customer community to the internal community to do some research in the internal community, wishes to switch back to the external Acme customer community to respond to an issue that a customer had. The user may open up the community switcher user interface component and click on a link to the external community to switch back to the customer community. At block 1028, the contextual information of the internal community may be saved so that the user may later return to the internal community to either ask another question or perform further research without starting from scratch at the home page of the internal community. Saving the contextual information of the internal community may be done by storing the contextual information in the session record associated with the internal community and the user.

In one example, the organizational domain that the session record is associated with may be “na1.salesforce.com”. When the selection of the link to the external community is made, the server 108 stores the currently displayed contextual information of the internal community in the session record associated with “na1.salesforce.com”. The contextual information may include an information feed, or a contextual sidebar with knowledge articles, or search results in the internal community, or a partially composed social media message, as generally described above at block 1012 of method 1000.

In another implementation, the contextual information may include object record information displayed in the internal community at the time the link to the external community is selected, and the object record information may be associated with one or more object records stored in a database. As an example, a case record or a customer account record may be displayed in the user interface when the link to the external community is selected, and the contextual information may include information associated with the case record or the customer account record.

In FIG. 10, at block 1032, the server 108 of the social networking system 104 performing method 1000 determines that an active session associated with the external community root domain exists. In some implementations, the server 108 does this by determining whether an active session record associated with the external community root domain and with the user exists in the database, as generally described above at block 1016.

In some implementations, block 1032 can be implemented as various methods described below with reference to FIG. 11B.

FIG. 11B shows a flowchart of two examples of a computer implemented method 1132 for determining that an active first session associated with the external community root domain exists, performed in accordance with some implementations. In FIG. 11B, at block 1140, the server 108 of the social networking system 104 performing method 1132 determines from the session information of the second session that an active first session exists at the external community root domain. As discussed above in block 1120, the session information may be stored in a session record in a database that is accessible by the server 108, and the server 108 may determine from the session record whether an active first session exists at the external community root domain.

In FIG. 11B, at block 1142, the server 108 updates the session expiration time of the session information of the first session to be the current time plus the session length of the external community. In some implementations, when an active session for the external community already exists and a request is made to switch to the external community, the server refreshes the session by updating the session expiration time of the active session associated with the external community.

Returning to FIG. 11B, at block 1150, the server 108 determines that an active first session does not exist at the external community root domain. As described in block 1120, the server 108 may determine from the database that stores the session records whether a session associated with the external community root domain and with the user exists, and whether that session has expired.

In FIG. 11B, at block 1152, the server 108 creates an active first session at the external community root domain. The session expiration time of the first session is the current time plus the session length of the external community. The domain of the first session may be set to the external community root domain and the user ID of the first session may be set to the user ID of the internal user.

Returning to FIG. 10, at block 1036, the server 108 of the social networking system 104 performing method 1000 identifies the contextual information stored in the session record associated with the external community. In some implementations, the server may search a session database for the session record associated with the user and the external community to determine if the session record includes any contextual information. The contextual information may be used to display the external community in the context in which it was presented when the user first switched away from the external community. The context may include one or more open object records, a list of results of a previously executed search, and the like. In some implementations, there may be no contextual information, in which case the external community may just be opened to its default home page.

In some implementations, the contextual information stored in the session record may be the actual content of the object records that comprised the context that was stored for the external community. In other implementations, the contextual information stored in the session record may contain pointers or indices to contextual object records in one or more databases.

In FIG. 10, at block 1040, the server 108 of the social networking system 104 performing method 1000 transmits data to display the external community at a display of the computing device 144. The transmitted data also includes the contextual information discussed above to be displayed in the external community.

In some implementations, this may allow a user switching from an internal community to an external community to view the external community in the same state in which he left it when he switched away from the external community. In an example, an Acme employee may have an open case in an external customer community, in which he is communicating with a customer in a feed of the customer community. He may then switch to an internal community to find a resource or to ask a colleague a question regarding the customer's case. When he switches back to the customer community, transmitting the contextual information allows the user to see the open case that he was working on and the feed in which he was communicating with the customer. This way, he does not need to track down the customer in the feed again or find the case that he opened again.

In other implementations where there is no contextual information, or where this is the first time in this session that the user is switching to the external community, the default home page of the external community may be displayed. As an example, FIG. 17 presents an example of a default home page of an external community.

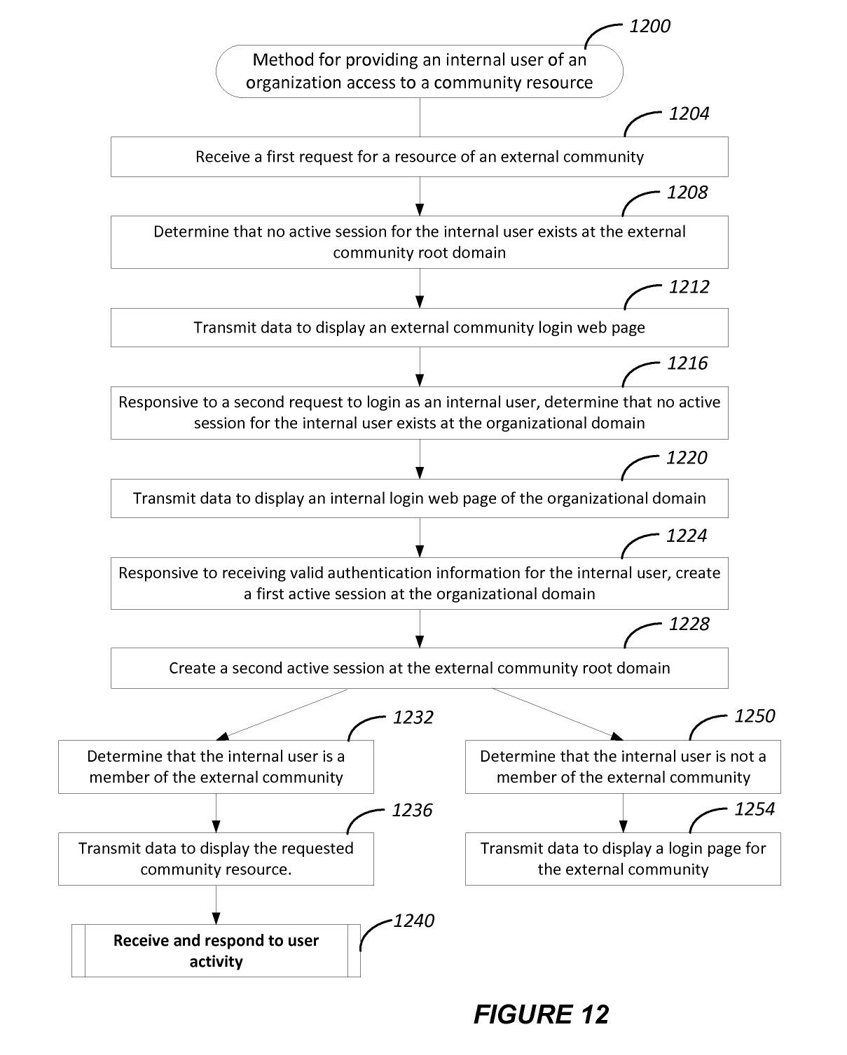

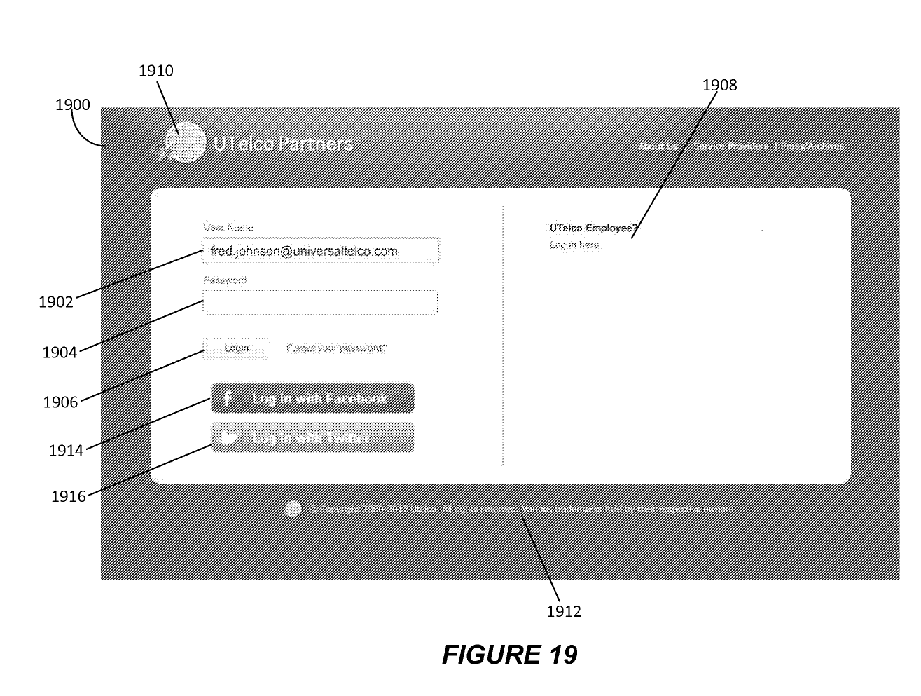

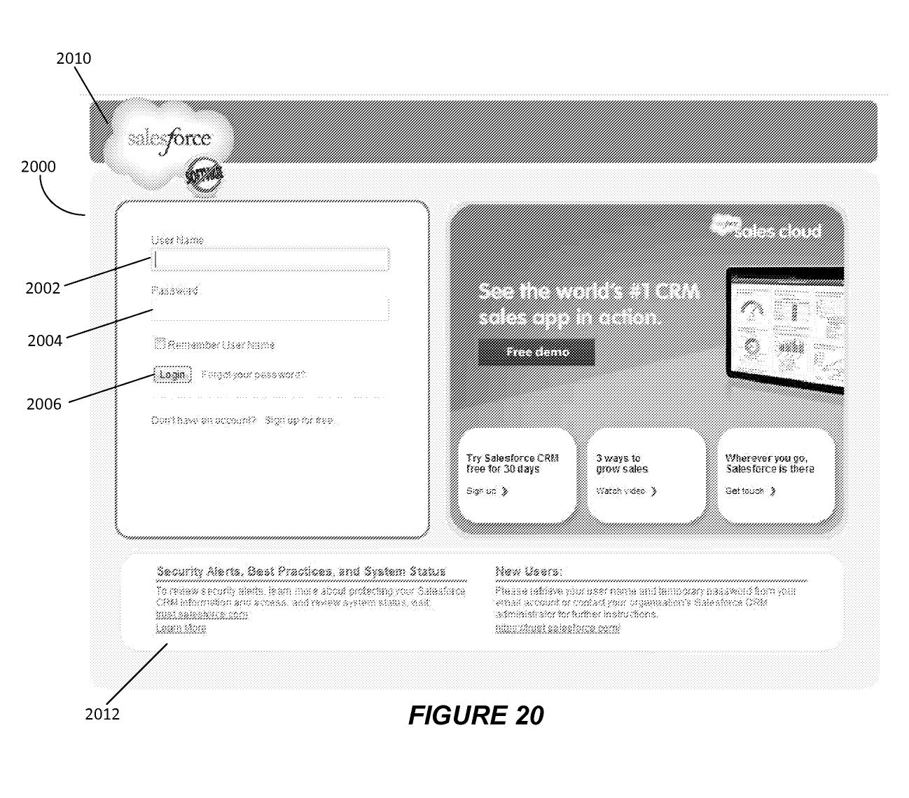

FIG. 12 shows a flowchart of an example of a computer implemented method 1200 for providing an internal user of an organization access to a community resource, performed in accordance with some implementations. FIG. 12 is described with reference to the examples of FIGS. 19 and 20.

In FIG. 12, at block 1204, a server, such as the server 108 of social networking system 104 in FIG. 1 described above, receives a request from an internal user for a resource of an external community, wherein the internal user is a member of both the external community as well as an internal community.

As an example, an internal community may be an Acme employee community, where Acme employees collaborate, post questions, and research the Acme knowledge database to address customer problems and work on Acme projects. The internal user in this example is an Acme employee that is a member of this Acme employee community. The Acme employee may also be a member of an external community, the Acme customer community, which is a community where Acme customers can interact with other Acme customers and with Acme employees to ask and research questions and resolve issues. In some implementations, the employee may interact with customers on the external Acme customer community to respond to their questions and to open cases for resolution. Customers who are members of the customer community, but are not employees, may not have access to the internal employee community. Moreover, employees may switch between the customer community and the employee community to gain information from other employees or from the employee knowledge database to assist in resolving a case for a customer in the customer community.

In some implementations, the difference between an organization's internal community and the organization's one or more external communities may be that only employees of the organization have access to the internal community. The employees may also have access to the external communities and may switch among the communities, but non-employee customers and partners who are members of the external communities may not have access to the internal community. In these implementations, there may be sensitive or confidential internal resources and information stored in the internal community that should not be accessible by customers and partners of the organization. Allowing an organization's employees to interact with customers and partners in a customer or partner community may provide an improved customer experience, as the customer may be able to ask questions, research topics that have been previously discussed in the community, and have direct contact with customer service representatives through the customer community. An employee working with a customer to resolve an issue may then switch back to the internal community to research the issue and gather resources to share with the customer back in the customer community.

Returning to block 1204, the external community is associated with an external community root domain, while the internal community is associated with an organizational domain. In the above example, the organizational domain associated with the internal community may be “na1.salesforce.com”, while the external community root domain associated with the external customer community may be “acme.force.com”. The internal community may be a community for Acme employees to collaborate and communicate with one another. The external customer community may be a community where any Acme customer may login and interact with other Acme customers and with Acme employees who also have access to the customer community. The complete path to the external customer community may be, for example, “acme.force.com/customercommunity” and a path to a resource of the external customer community may be “acme.force.com/customercommunity/resource1”. In the above example, when the request from the internal user for the resource of the external community is a request for “acme.force.com/customercommunity/resource1”, the server 108 may identify the external community root domain of the requested resource as “acme.force.com” and the organizational domain for the corresponding internal community as “na1. salesforce.com”.

In some implementations, where there is more than one external community associated with the Acme organization, for example a partner community, the other external communities may be associated with the same external community root domain, “acme.force.com”, such that the path to an external Acme partner community may be “acme.force.com/partnercommunity”. The organizational domain of the internal community, “na1.salesforce.com”, may be associated with the external community root domain “acme.force.com”, such that an Acme employee attempting to login to “acme.force.com” will be redirected to the organizational domain, “na1.salesforce.com” to login.

In some implementations the organizational domain may include an identifier for the organization. For example, in the Acme example, the organizational domain may be “acme.my.salesforce.com” and this organizational domain may be associated with all of Acme's external communities. Using a domain like “acme.my.salesforce.com” may provide Acme employees a more familiar branded experience when they login to the Acme internal community.

In some implementations, serving the internal community from an organizational domain that is different from the external community root domain that is serving the external communities allows an organization to choose custom domains for its external communities. Moreover, maintaining separate sessions for the internal and external communities and requiring internal users to login through the internal community login page allows an administrator of the social networking system 104 to impose particular login security requirements for the internal community that he does not have to impose on external users of the external communities. For example, an administrator of the Acme internal community may wish to require all Acme employee users of the internal community to change their passwords every 30 days, or to maintain passwords that are at least ten characters long with one or more special characters, or to login only from a particular range of IP addresses. The IP restrictions may allow an internal user to login only from certain geographical locations, or prevent him from logging in from particular geographical locations. An administrator may want to do this because the internal community contains Acme's private information meant only for employees to access. Because a separate session is maintained for the internal community, the administrator may direct the server 108 of the social networking system 104 to enforce these restrictions for Acme employee users logging into the internal community.

By maintaining a separate session for the external communities, the administrator can impose looser security requirements for login, since users of the external communities do not have access to sensitive Acme organization information. Moreover, having a separate session for the external communities may also open up the possibility of allowing Acme customers to login to the customer community by using credentials from other social networking systems, like Facebook®, Twitter®, LinkedIn®, or Google®, as described below at block 1212. This could save the customer from having yet another user name and password to remember for their Acme customer community login.

In FIG. 12, at block 1208, the server 108 of social networking system 104 performing method 1200 is configured to determine that no active session for the internal user exists at the external community root domain. The server may determine, based on the first request, whether an active session associated with the root domain of the first request exists. In one example, where the request may be for a resource “acme.force.com/customercommunity/resource2”, the server may determine that no active session associated with the internal user and with the external community root domain, “acme.force.com”, exists.

In some implementations, the server may determine that no active session exists for the internal user at the external community root domain and transmit data to display a login page for the external community, where the login page display includes a link that allows the internal user to identify himself as an internal user and to redirect the browser to a servlet running at the organizational domain. The servlet may then determine that there is no active session present for the internal user at the organizational domain as well.

In FIG. 12, at block 1212, the server 108 of social networking system 104 performing method 1200 is configured to transmit data to display an external login page of the external community root domain. The external login page provides an option for the internal user to request to login as an internal user, in addition to an option to login as an external customer user.

FIG. 19 shows an example of a graphical user interface (GUI) including a presentation of an external community login page to a user at a computing device, according to some implementations. FIG. 19 illustrates an example of a UTelco Partners community login page, where external partner users may login to the partners community.

In some implementations, an external user or partner may login to the partners community by entering his user name and password for the external community in the fields 1902 and 1904. The user name and password may be issued to the user by salesforce.com, inc. to login to any salesforce.com, inc. external community. In another implementation, the user name and password may be unique to the partners community.

In other implementations, an external user may be presented with options to login with credentials from another social networking system or online social network. In FIG. 19, the Facebook® link 1914 and the Twitter® link 1916 present options to login using a Facebook® account or a Twitter® account. Other implementations may allow a user to login using other online social network accounts. This may allow the user to have one fewer user name and password to keep track of and push the user authentication duties to the other online social network.

The external community login page 1900 may also provide a user with a completely branded experience. In the example of FIG. 19, the header 1910 and the footer 1912 of the login page 1900 contain the UTelco branding theme. In some implementations, the theme may include font selection, color schemes, and styling of the text fields and buttons. For example, at “utelco.force.com/partnerscommunity”, an external partner user may get a completely branded experience when logging into the UTelco Partners Community.

In some implementations, if an internal user attempts to login via the external community login page 1900, the server 108 may redirect the internal user to the login page of the internal community, requiring him to login through the internal community login page, described below at block 1220. Once the internal user has logged in via the internal community, he may seamlessly switch between the internal community and external communities that he is a member of using method 1000 of FIG. 10.

In FIG. 12, at block 1216, the server 108 of social networking system 104 performing method 1200, responsive to a second request to login as an internal user, determines that no active session for the internal user exists at the organizational domain. In some implementations, the request to login as an internal user may occur when the user clicks on the internal user link 1908 in the external community login page of FIG. 19.

In another implementation, if the server 108 is aware that the user is an internal user, the request to login as an internal user may be performed automatically by the server 108. For example, if the first request for the external community resource included the user ID, the server 108 may be able to determine that the user is an internal user without requiring the user to click on the internal user link 1908 in the external community login page. In this example, the server 108 may determine that the user is an internal user, and automatically determine that no active session for the user exists at the organizational domain and move onto block 1220.

In FIG. 12, at block 1220, the server 108 of social networking system 104 performing method 1200 transmits data to display an internal login web page of the organizational domain.

FIG. 20 shows an example of a graphical user interface (GUI) including a presentation of an internal community login page to a user at a computing device, according to some implementations. FIG. 20 illustrates an example of an internal community login page, where internal users of organizational domains login with their internal user name and password to access their internal organizational community. As an example, an Acme employee may be presented with this login page when he wishes to login to the Acme employee community hosted by the server 108 of the social networking system 104.

When an internal user logs in through the organizational domain, the server may impose the more restrictive login requirements discussed above at block 1204 when authenticating the internal user's credentials.

The internal community login page 2000 of FIG. 20 contains a standard salesforce.com, inc. header and footer. An internal user may login to the internal community by entering his user name in the user name field 2002 and his password in the password field 2004 and clicking the login button 2006 to trigger the authentication step.

In some implementations, when an organization's internal community is hosted at a branded domain, such as “acme.my.salesforce.com”, the header and footer may be branded with Acme's color scheme and logos, to provide Acme employees with an Acme-branded login experience when logging into the Acme employee community.

In FIG. 12, at block 1224, the server 108 of social networking system 104 performing method 1200 is configured to receive valid authentication information from the internal user. In some implementations, verification of the authentication information may be performed by the server 108 with access to databases 112 and 116. In the above example, where an Acme employee is logging into an internal Acme employee community at the organizational domain, “na1.salesforce.com”, it is the server 108 that may verify the authentication information. In other implementations, a delegated authentication single sign-on process may be used, in which verification of the internal user's authentication information is not performed by the server 108. Rather, the server 108 passes the authentication information to an Acme corporate user database for verification. Other authentication methods known in the art, such as SAML may also be used. If Acme permits its employees to login with credentials of other social networking providers, such as Facebook® and Twitter®, then external authentication providers may also be used to facilitate authentication of the user.

Returning to block 1224, the server 108, responsive to receiving valid authentication information for the internal user, creates a first active session at the organizational domain. The first active session may be a parent session, and the session information of the parent session may include the organizational domain, the user ID of the internal user, and a session expiration time that is the time of creation of the parent session plus the session length of the internal community.

In FIG. 12, at block 1228, the server 108 of social networking system 104 performing method 1200 creates a second active session at the external community root domain. This second active session may be a child session in some implementations, with the first active session associated as the parent of the child session. The session information of the child session includes the external community root domain, the user ID of the internal user, and a session expiration time that is time of creation of the child session plus the session length of the external community.

In FIG. 12, at block 1232, the server 108 of social networking system 104 performing method 1200 determines that the internal user is a member of the external community. The server 108 may determine this by using the user ID mapping table 400 of FIGS. 3 and 4, which is stored in a database 332 of the social networking system 104. If the internal user's user ID appears in the mapping table 400 under the community User ID column 416, 420, or 424 corresponding to the external community, then the internal user is a member of that external community. For example, in FIG. 4, snelson@media1.com is a member of Community 1A and Community 1B, but is not a member of Community 2.

In FIG. 12, at block 1236, the server 108 of social networking system 104 performing method 1200 transmits data to display at the computing device 144 the requested community resource in the external community. The resource may be an information feed, a feed item, a help article, an account record, or the like.

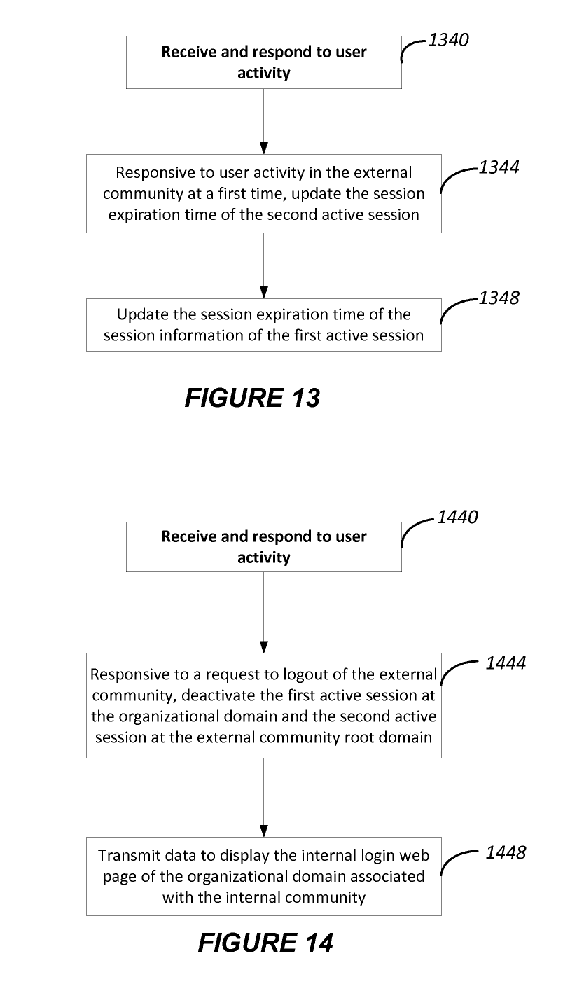

In FIG. 12, at block 1240, the server 108 of social networking system 104 performing method 1200 is configured to receive and respond to user activity. Block 1240 can be implemented as various methods described below with reference to FIGS. 13 and 14.

FIG. 13 shows a flowchart of an example of a computer implemented method 1340 for receiving and responding to user activity, as one of various implementations of block 1240 of method 1200, performed in accordance with some implementations. In FIG. 13, at block 1344, the server 108 of social networking system 104 performing method 1340, responsive to user activity in the external community, updates the session expiration time of the second active session associated with the external community.

In some implementations, where the external communities of an organization are all hosted at a single external community root domain, and a single session is maintained at the root domain for all of the external communities, then activity in one of the external communities will refresh the session for all of the external communities. For example, the Acme customer community (“acme.force.com/customercommunity”) and the Acme partner community (“acme.force.com/partnercommunity”) are hosted at the same external community root domain (“acme.force.com”), and the child session that is maintained for the external communities is hosted at the root domain (“acme.force.com”). When there is user activity in the Acme customer community, the session expiration time of the child session associated with the root domain is updated to the current time plus the session length of the customer community. Because the customer community and the partner community share the same session, the partner community's session is also refreshed by the activity in the customer community.

In FIG. 13, at block 1344, the server 108 of social networking system 104 performing method 1340 updates the session expiration time of the session information of the first active session associated with the internal community.

In some implementations, activity in the external community may also refresh the parent session of the internal community associated with the external community. In the above example, an internal user's activity in the customer community may not only lead to updating the session expiration time of the child session of the external communities, but it may also lead to updating the session expiration time of the parent session at the organizational domain (“na1.salesforce.com”). Because the parent session and child session are associated with one another as parent and child, the server may determine which parent session to update when a child session is being updated due to user activity.

In some implementations, updating both the parent and child sessions in response to user activity in the child session provides the user with a more seamless experience switching among the communities. Because activity in one external community refreshes the session for all of the external community, a user will not be required to log into a second external community after working in a first external community for a length of time longer than the session length of the second external community. Moreover, because activity in an external community refreshes the parent session for the internal community as well, the user may switch seamlessly from the external community to the internal community without having to login again to the internal community, because the activity in the external community kept the internal parent session alive.

In other implementations, activity in the internal community may also refresh both the parent session associated with the internal community and the child session associated with the external communities, also providing a more seamless community switching experience.

FIG. 14 shows a flowchart of an example of a computer implemented method 1440 for receiving and responding to user activity, as another one of various implementations of block 1240 of method 1200, performed in accordance with some implementations. In FIG. 14, at block 1444, the server 108 of social networking system 104 performing method 1440, responsive to a request to logout of the external community, deactivates the first active session at the organizational domain and the second active session at the external community root domain.

In some implementations, when an internal user logs out of one external community (“acme.force.com/customercommunity”), that terminates the session associated with the external community root domain (“acme.force.com”). Because the other Acme external communities (e.g. “acme.force.com/partnercommunity”) are also hosted by the same root domain (“acme.force.com”), logging out of one external community will log the user out of all of the external communities hosted at the same root domain. Furthermore, logging out of an external community may also terminate the parent session of the internal community of the organization. For example, logging out of the Acme customer community may also cause the internal user to be logged out of the internal Acme employee community. This allows an internal user to not have to log out of each community separately, and allows the internal user to experience all of the communities that he is a member of in a unified way.

In FIG. 14, at block 1448, the server 108 of social networking 104 performing method 1440 transmits data to display the internal login web page of the organizational domain associated with the internal community. In some implementations, upon logging out of the external community, the internal user may then be presented with the internal login web page of the organizational domain.

Returning to block 1250 in FIG. 12, the server 108 of social networking system 104 performing method 1200, after creating the second active session at the external community root domain, determines that the internal user is not a member of the external community. As discussed above at block 1232, the server 108 may determine this by using the user ID mapping table 400 of FIGS. 3 and 4, which is stored in a database 332 of the social networking system 104. If the internal user's user ID does not appear in the mapping table 400 under the community User ID column 416, 420, or 424 corresponding to the external community, then the internal user is not a member of that external community. For example, in FIG. 4, user bsmith@acme.com is not a member of Community 1B or Community 2.

In FIG. 12, at block 1254, the server 108 of social networking system 104 performing method 1200 transmits data to display a login page for the external community of the requested resource. The external community login page is described above block 1212 with reference to FIG. 19.

Additional examples of systems, apparatus, and methods are disclosed herein for implementing enterprise level social and business information networking Such implementations can provide more efficient use of a database system. For instance, a user of a database system may not easily know when important information in the database has changed, e.g., about a project or client. Implementations can provide feed tracked updates about such changes and other events, thereby keeping users informed.

By way of example, a user can update a record, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed right to the manager's feed page or other page.

Mechanisms and methods for providing systems implementing enterprise level social and business information networking are disclosed herein with reference to several implementations. Examples of database systems are described and can provide a platform for tracking events related to a record, actions of a user, and messages about a user or record. The disclosed systems support various data structures of feeds, the customization of feeds, selection of records and users to follow, generation of feeds, and display of feeds in suitable presentations on a user's display device.

FIG. 23A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 23A (and in more detail in FIG. 23B) user systems 12 might interact via a network 14 with an on-demand database service, which is implemented in the example of FIG. 23A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 23A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 23A and 23B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 23A include conventional, well-known elements that are explained only briefly here. For example, each user system 12 could include a desktop personal computer, workstation, laptop, PDA, tablet, smartphone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 23B shows a block diagram of an example of some implementations of elements of FIG. 23A and various possible interconnections between these elements. That is, FIG. 23B also illustrates environment 10. However, in FIG. 23B elements of system 16 and various interconnections in some implementations are further illustrated. FIG. 23B shows that user system 12 may include processor system 12A, memory system 12B, input system 12C, and output system 12D. FIG. 23B shows network 14 and system 16. FIG. 23B also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 23A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 23B, system 16 may include a network interface 20 (of FIG. 23A) implemented as a set of HTTP application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 24A shows a system diagram illustrating an example of architectural components of an on-demand database service environment 2400 according to some implementations. A client machine located in the cloud 2404, generally referring to one or more networks in combination, as described herein, may communicate with the on-demand database service environment via one or more edge routers 2408 and 2412. A client machine can be any of the examples of user systems 12 described above. The edge routers may communicate with one or more core switches 2420 and 2424 via firewall 2416. The core switches may communicate with a load balancer 2428, which may distribute server load over different pods, such as the pods 2440 and 2444. The pods 2440 and 2444, which may each include one or more servers and/or other computing resources, may perform data processing and other operations used to provide on-demand services. Communication with the pods may be conducted via pod switches 2432 and 2436. Components of the on-demand database service environment may communicate with a database storage 2456 via a database firewall 2448 and a database switch 2452.

As shown in FIGS. 24A and 24B, accessing an on-demand database service environment may involve communications transmitted among a variety of different hardware and/or software components. Further, the on-demand database service environment 2400 is a simplified representation of an actual on-demand database service environment. For example, while only one or two devices of each type are shown in FIGS. 24A and 24B, some implementations of an on-demand database service environment may include anywhere from one to many devices of each type. Also, the on-demand database service environment need not include each device shown in FIGS. 24A and 24B, or may include additional devices not shown in FIGS. 24A and 24B.

Moreover, one or more of the devices in the on-demand database service environment 2400 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 2404 is intended to refer to a data network or plurality of data networks, often including the Internet. Client machines located in the cloud 2404 may communicate with the on-demand database service environment to access services provided by the on-demand database service environment. For example, client machines may access the on-demand database service environment to retrieve, store, edit, and/or process information.

In some implementations, the edge routers 2408 and 2412 route packets between the cloud 2404 and other components of the on-demand database service environment 2400. The edge routers 2408 and 2412 may employ the Border Gateway Protocol (BGP). The BGP is the core routing protocol of the Internet. The edge routers 2408 and 2412 may maintain a table of IP networks or ‘prefixes’, which designate network reachability among autonomous systems on the Internet.

In one or more implementations, the firewall 2416 may protect the inner components of the on-demand database service environment 2400 from Internet traffic. The firewall 2416 may block, permit, or deny access to the inner components of the on-demand database service environment 2400 based upon a set of rules and other criteria. The firewall 2416 may act as one or more of a packet filter, an application gateway, a stateful filter, a proxy server, or any other type of firewall.

In some implementations, the core switches 2420 and 2424 are high-capacity switches that transfer packets within the on-demand database service environment 2400. The core switches 2420 and 2424 may be configured as network bridges that quickly route data between different components within the on-demand database service environment. In some implementations, the use of two or more core switches 2420 and 2424 may provide redundancy and/or reduced latency.

In some implementations, the pods 2440 and 2444 may perform the core data processing and service functions provided by the on-demand database service environment. Each pod may include various types of hardware and/or software computing resources. An example of the pod architecture is discussed in greater detail with reference to FIG. 24B.

In some implementations, communication between the pods 2440 and 2444 may be conducted via the pod switches 2432 and 2436. The pod switches 2432 and 2436 may facilitate communication between the pods 2440 and 2444 and client machines located in the cloud 2404, for example via core switches 2420 and 2424. Also, the pod switches 2432 and 2436 may facilitate communication between the pods 2440 and 2444 and the database storage 2456.

In some implementations, the load balancer 2428 may distribute workload between the pods 2440 and 2444. Balancing the on-demand service requests between the pods may assist in improving the use of resources, increasing throughput, reducing response times, and/or reducing overhead. The load balancer 2428 may include multilayer switches to analyze and forward traffic.

In some implementations, access to the database storage 2456 may be guarded by a database firewall 2448. The database firewall 2448 may act as a computer application firewall operating at the database application layer of a protocol stack. The database firewall 2448 may protect the database storage 2456 from application attacks such as structure query language (SQL) injection, database rootkits, and unauthorized information disclosure.

In some implementations, the database firewall 2448 may include a host using one or more forms of reverse proxy services to proxy traffic before passing it to a gateway router. The database firewall 2448 may inspect the contents of database traffic and block certain content or database requests. The database firewall 2448 may work on the SQL application level atop the TCP/IP stack, managing applications' connection to the database or SQL management interfaces as well as intercepting and enforcing packets traveling to or from a database network or application interface.

In some implementations, communication with the database storage 2456 may be conducted via the database switch 2452. The multi-tenant database storage 2456 may include more than one hardware and/or software components for handling database queries. Accordingly, the database switch 2452 may direct database queries transmitted by other components of the on-demand database service environment (e.g., the pods 2440 and 2444) to the correct components within the database storage 2456.

In some implementations, the database storage 2456 is an on-demand database system shared by many different organizations. The on-demand database system may employ a multi-tenant approach, a virtualized approach, or any other type of database approach. An on-demand database system is discussed in greater detail with reference to FIGS. 23A and 23B.

FIG. 24B shows a system diagram further illustrating an example of architectural components of an on-demand database service environment according to some implementations. The pod 2444 may be used to render services to a user of the on-demand database service environment 2400. In some implementations, each pod may include a variety of servers and/or other systems. The pod 2444 includes one or more content batch servers 2464, content search servers 2468, query servers 2482, file force servers 2486, access control system (ACS) servers 2480, batch servers 2484, and app servers 2488. Also, the pod 2444 includes database instances 2490, quick file systems (QFS) 2492, and indexers 2494. In one or more implementations, some or all communication between the servers in the pod 2444 may be transmitted via the switch 2436.

In some implementations, the app servers 2488 may include a hardware and/or software framework dedicated to the execution of procedures (e.g., programs, routines, scripts) for supporting the construction of applications provided by the on-demand database service environment 2400 via the pod 2444. In some implementations, the hardware and/or software framework of an app server 2488 is configured to execute operations of the services described herein, including performance of the blocks of methods described herein. In alternative implementations, two or more app servers 2488 may be included and cooperate to perform such methods, or one or more other servers described herein can be configured to perform the disclosed methods.

The content batch servers 2464 may handle requests internal to the pod. These requests may be long-running and/or not tied to a particular customer. For example, the content batch servers 2464 may handle requests related to log mining, cleanup work, and maintenance tasks.

The content search servers 2468 may provide query and indexer functions. For example, the functions provided by the content search servers 2468 may allow users to search through content stored in the on-demand database service environment.

The file force servers 2486 may manage requests for information stored in the Fileforce storage 2498. The Fileforce storage 2498 may store information such as documents, images, and basic large objects (BLOBs). By managing requests for information using the file force servers 2486, the image footprint on the database may be reduced.

The query servers 2482 may be used to retrieve information from one or more file systems. For example, the query system 2482 may receive requests for information from the app servers 2488 and then transmit information queries to the NFS 2496 located outside the pod.

The pod 2444 may share a database instance 2490 configured as a multi-tenant environment in which different organizations share access to the same database. Additionally, services rendered by the pod 2444 may call upon various hardware and/or software resources. In some implementations, the ACS servers 2480 may control access to data, hardware resources, or software resources.

In some implementations, the batch servers 2484 may process batch jobs, which are used to run tasks at specified times. Thus, the batch servers 2484 may transmit instructions to other servers, such as the app servers 2488, to trigger the batch jobs.

In some implementations, the QFS 2492 may be an open source file system available from Sun Microsystems® of Santa Clara, Calif. The QFS may serve as a rapid-access file system for storing and accessing information available within the pod 2444. The QFS 2492 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 2468 and/or indexers 2494 to identify, retrieve, move, and/or update data stored in the network file systems 2496 and/or other storage systems.

In some implementations, one or more query servers 2482 may communicate with the NFS 2496 to retrieve and/or update information stored outside of the pod 2444. The NFS 2496 may allow servers located in the pod 2444 to access information to access files over a network in a manner similar to how local storage is accessed.

In some implementations, queries from the query servers 2422 may be transmitted to the NFS 2496 via the load balancer 2428, which may distribute resource requests over various resources available in the on-demand database service environment. The NFS 2496 may also communicate with the QFS 2492 to update the information stored on the NFS 2496 and/or to provide information to the QFS 2492 for use by servers located within the pod 2444.

In some implementations, the pod may include one or more database instances 2490. The database instance 2490 may transmit information to the QFS 2492. When information is transmitted to the QFS, it may be available for use by servers within the pod 2444 without using an additional database call.

In some implementations, database information may be transmitted to the indexer 2494. Indexer 2494 may provide an index of information available in the database 2490 and/or QFS 2492. The index information may be provided to file force servers 2486 and/or the QFS 2492.

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know. Accordingly, some implementations of the disclosed techniques can inform others (e.g., co-workers) who want to know about an update to a record automatically.

The tracking and reporting of updates to a record stored in a database system can be facilitated with a multi-tenant database system 16, e.g., by one or more processors configured to receive or retrieve information, process the information, store results, and transmit the results. In other implementations, the tracking and reporting of updates to a record may be implemented at least partially with a single tenant database system.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer-implemented method for providing an internal user of an organization a community switcher user interface component in a user interface for switching between an external community that the internal user is a member of and an internal community, the internal community established at an organizational domain, the external community established at an external community root domain, the internal and external communities each having an associated session length, the method comprising:
receiving a request to display a community switcher user interface component; and
transmitting data to display the requested community switcher user interface component, wherein the community switcher user interface component includes a link to the internal community and a link to the external community.

2. The method of claim 1, wherein the link to the external community includes an indicator associated with the status of the community.

3. The method of claim 2, wherein the status of the community is one of: online, offline, or under construction.

4. The method of claim 3, wherein the visibility to the internal user of one or more of the links depends on the status of the community associated with the links.

5. The method of claim 1, wherein the organizational domain and the external community root domain are hosted by the same server.

6. The method of claim 1, wherein the link to the internal community is displayed under a first category of links in the community switcher user interface component and the link to the external community is displayed under a second category of links in the community switcher user interface component.

7. The method of claim 1, wherein the community switcher user interface component includes an indicator indicating the community that the internal user is currently viewing.

8. The method of claim 1, the method further comprising:
responsive to a selection of the link to the internal community at a first time, storing in a first session record in a first database first contextual information of the external community, the first session record including first session information associated with a first session, the first session associated with the external community root domain;
determining that an active second session associated with the organizational domain exists, wherein the active second session is associated with second session information stored in a second session record in a second database; and
transmitting data to display the internal community.

9. The method of claim 8, wherein the first contextual information includes object record information displayed in the user interface at the first time, the object record information associated with one or more object records stored in an object record database.

10. The method of claim 8, wherein the second session has a child-parent relationship or a parent-child relationship with the first session.

11. The method of claim 8, wherein the first and second session information each include a user ID associated with the internal user, a session expiration time, and a domain.

12. The method of claim 11, wherein the step of determining that an active second session associated with the organizational domain exists comprises:
determining at the first time from the second session information that an active second session exists at the organizational domain; and
updating the session expiration time of the second session information to be the first time plus the session length of the internal community.

13. The method of claim 11, wherein the step of determining that an active second session associated with the organizational domain exists comprises:
determining at the first time from the second session information that an active second session does not exist at the organizational domain; and
creating an active second session at the organizational domain, wherein the session expiration time of the second session information of the active second session is the first time plus the session length of the internal community.

14. The method of claim 11, the method further comprising:
responsive to a selection of the link to the external community at a second time, storing in the second session record in the second database second contextual information of the internal community;
determining that an active first session associated with the external community root domain exists;
identifying the first contextual information stored in the first session record; and
transmitting data to display the external community, the transmitted data including the first contextual information.

15. The method of claim 14, wherein the second contextual information includes object record information displayed in the user interface at the second time, the object record information associated with one or more object records stored in an object record database.

16. The method of claim 14, wherein the step of determining that an active first session associated with the external community root domain exists comprises:
determining at the second time from the first session information that an active first session exists at the external community root domain; and
updating the session expiration time of the first session information to be the second time plus the session length of the external community.

17. The method of claim 14, wherein the step of determining that an active first session associated with the external community root domain exists comprises:
determining at the second time from the first session information that an active first session does not exist at the external community root domain;
creating an active first session at the external community root domain, wherein the session expiration time of the first session information of the active first session is the second time plus the session length of the external community.

18. A computer-implemented method for providing an internal user of an organization access to an external community resource, the method comprising:
receiving at a server a first request from the internal user of the organization for a resource of an external community, the external community having an external community root domain, the internal user having access to an internal community, the internal community having an organizational domain;
determining that no active session for the internal user exists at the external community root domain;
transmitting data to display an external community login web page of the external community root domain, the external community login web page providing one or more options for login to the external community as an external user, the external community login web page further displaying a prompt for a user to request to login as an internal user;
responsive to a second request to login as an internal user, determining that no active session for the internal user exists at the organizational domain;
transmitting data to display an internal login web page of the organizational domain;
responsive to receiving at the server valid authentication information for the internal user, creating a first active session at the organizational domain; and
creating a second active session at the external community root domain.

19. The method of claim 18, the method further comprising:
determining that the internal user is a member of the external community; and
transmitting data to display at a display device a resource web page of the external community root domain, the resource web page containing the requested community resource.

20. The method of claim 18, the method further comprising:
determining that the internal user is not a member of the external community; and
transmitting data to display an external community login web page for the external community.

21. The method of claim 18, wherein the second active session has a child-parent relationship or a parent-child relationship with the first active session, wherein the first active session is a parent session and the second active session is a child session.

22. The method of claim 18, wherein the first active session and the second active session each contain associated session information, including: a user ID associated with the internal user, a session expiration time, and a domain.

23. The method of claim 22, wherein the domain of the first active session is the organizational domain, and wherein the domain of the second active session is the external community root domain.

24. The method of claim 23, wherein the internal and external communities each have an associated session length, the method further comprising:
responsive to user activity in the external community at a first time, updating the session expiration time of the session information of the second active session, the updated session expiration time being the first time plus a period of time equal to the session length of the external community; and
updating the session expiration time of the session information of the first active session, wherein the updated session expiration time is the first time plus a period of time equal to the session length of the internal community.

25. The method of claim 23, the method further comprising:
responsive to a second request to logout of the external community, deactivating the first active session at the organizational domain and the second active session at the external community root domain; and
transmitting data to display the internal login web page of the organizational domain associated with the internal community.

26. One or more computing devices for providing an internal user of an organization a community switcher user interface component in a user interface for switching between an external community that the internal user is a member of and an internal community, the internal community established at an organizational domain, the external community established at an external community root domain, the internal and external communities each having an associated session length, the one or more computing devices comprising:
one or more processors operable to execute one or more instructions to:
receive a request to display a community switcher user interface component;
transmit data to display the requested community switcher user interface component, wherein the community switcher user interface component includes a link to the internal community and a link to the external community;
responsive to a selection of the link to the internal community at a first time, store in a first session record in a first database first contextual information of the external community, the first session record including first session information associated with a first session, the first session associated with the external community root domain;
determine that an active second session associated with the organizational domain exists, wherein the active second session is associated with second session information stored in a second session record in a second database; and
transmit data to display the internal community.

27. A non-transitory computer-readable storage medium storing instructions executable by a computing device to perform a method for providing an internal user of an organization a community switcher user interface component in a user interface for switching between an external community that the internal user is a member of and an internal community, the internal community established at an organizational domain, the external community established at an external community root domain, the internal and external communities each having an associated session length, the method comprising:
receiving a request to display a community switcher user interface component;
transmitting data to display the requested community switcher user interface component, wherein the community switcher user interface component includes a link to the internal community and a link to the external community;
responsive to a selection of the link to the internal community at a first time, storing in a first session record in a first database first contextual information of the external community, the first session record including first session information associated with a first session, the first session associated with the external community root domain;
determining that an active second session associated with the organizational domain exists, wherein the active second session is associated with second session information stored in a second session record in a second database; and
transmitting data to display the internal community.
